(19) United States
(12) Patent Application Publication
(10) Pub. No.: US 2011/0054840 A1
(43) Pub. Date: Mar. 3, 2011

(54) FAILURE PREDICTION OF COMPLEX STRUCTURES UNDER ARBITRARY TIME-SERIAL LOADING CONDITION

(76) Inventors: Lee M. Hively, Philadelphia, TN (US); Robert K. Abercrombie, Knoxville, TN (US); Fredrick T. Sheldon, Knoxville, TN (US)

(21) Appl. No.: 12/548,206

(22) Filed: Aug. 26, 2009

(51) Int. Cl. G01N 3/32; G01L 1/00

(52) U.S. Cl. 702/182; 702/42; 702/35

(57) ABSTRACT

A method and apparatus for the nonlinear detection of imminent failure in a complex structural element is disclosed. The method and apparatus include sensing stress and strain displacement-related data for said structural element, analyzing the sensed stress and strain displacement-related data as a function of one or more principle components, generating a crack-growth rate function relating said data for each principle component over a load/unload cycle, determining a total crack-growth rate function based on at least one crack-growth rate function, deriving from said total crack-growth rate function at least one indicator function, monitoring trends in said at least one indicator function, and providing an indication when said monitoring detects an end-stage trend in said at least one indicator function.

### CROSS-REFERENCE TO RELATED APPLICATIONS

This patent is related to pending U.S. patent application Ser. No. 12/072,309, titled “Method and System for Reducing Errors in Vehicle Weighing Systems,” filed on Feb. 26, 2008, the entire content of which is hereby incorporated by reference.

This patent is related to pending U.S. patent application Ser. No. 11/583,473, titled “Method and System for Determining a Volume of an Object from Two-Dimensional Images,” filed on Oct. 18, 2006.

This patent is related to U.S. Pat. No. 7,375,293, titled “System and Method for Weighing and Characterizing Moving or Stationary Vehicles and Cargo,” filed on May 20, 2008, the entire content of which is hereby incorporated by reference.

This patent is related to U.S. Pat. No. 7,305,324, titled “System and Method for Identifying, Validating, and Characterizing Moving or Stationary Vehicles and Cargo,” filed on Dec. 4, 2007, the entire content of which is hereby incorporated by reference.

This patent is related to U.S. Pat. No. 6,460,012, titled “Nonlinear Structural crack growth monitoring,” filed on Sep. 16, 1999, the entire content of which is hereby incorporated by reference.

This patent is related to U.S. Pat. No. 4,770,492, titled “Pressure or Strain Sensitive Optical Fiber,” filed Oct. 28, 1986, the entire content of which is hereby incorporated by reference.

This patent is related to U.S. Pat. No. 4,421,979, title “Microbending of Optical Fibers for Remote Force Measurement,” filed Aug. 27, 1981, the entire content of which is hereby incorporated by reference.

This patent is related to U.S. Pat. No. 4,191,470, titled “Laser-Fiber Optic Interferometric Strain Gauge,” filed on Sep. 18, 1978, the entire content of which is hereby incorporated by reference.

### STATEMENT OF GOVERNMENT RIGHTS

This invention was made with Government support under Contract Number DE-AC05-00OR22725 awarded by the United States Department of Energy, and the United States Government has certain rights in this invention.

### TECHNICAL FIELD

The disclosure relates generally to determinations of the remaining useful life of structures and structural elements. More particularly, the disclosure relates to methods and apparatus enabling the nonlinear detection of imminent structural failure in complex structures due to induced crack growth.

### BACKGROUND

Structural elements of any kind are subject to a variety of stresses that will ultimately result in the failure of the element. Examples of stresses are tensile, flexure, or shear stresses resulting from applied loads, the loads being applied either (a) statically, (b) periodically, or (c) dynamically as a complex waveform. Environmental corrosion can also constitute a stress to the structure. The applied load and environmental stresses, each acting separately or in combination, result in the creation and propagation of cracks in the structural element. The proliferation of cracks eventually causes one (or more) elements of the structure to fail.

It has long been a goal of those concerned with the useful life and eventual failure of structural elements to accurately predict the imminent failure of such elements. A primary consideration is safety, inasmuch as the failure of an element in, for example, a bridge or a mechanism such as a train car, can have a direct effect on the safety of people using the bridge or riding the train. A second significant concern is economics. While allowing a structural element to approach too closely its estimated time of failure creates the risk of an earlier than expected failure, which is a significant safety risk, repairing or replacing the element too early in its useful life is expensive. Utilizing too large a safety factor can waste a significant portion of the actual useful life of the element, contributing to higher costs for the element and/or the structure of which it is a part.

One type of failure of a structural element is tensile fatigue failure. An analytically simple method for predicting tensile fatigue failure due to fatigue crack growth is to subject a statistically significant number of the structural elements in question to empirical and/or experimental end-of-life (EOL) testing. This approach involves testing to destruction under stress conditions intended to duplicate those expected to be found in actual use. The results enable a determination of a mean value for and the variability in actual time to failure for a given set of loading, frequency, and environmental conditions. A predetermined safety factor can be incorporated in a prediction of structural service life to balance safety against utilizing as much of the useful life of the element as possible.

This method and equivalent methods for predicting failure due to other types of stress, however, are cumbersome, expensive, and time-consuming. Moreover, in the aforementioned fatigue failure method, for example, the material property determination of a mean value and the variability of the number of cycles to failure are also affected by the nature and frequency of the applied loadings and the environmental conditions over the service life of the structure. In addition, for multiple loadings, such prediction requires knowledge about which loading type drives the failure. Also, where the safety is concern is very high, such as for a high speed mass transit vehicle, the predictive window provided by such tests is too broad for accurate use with a particular structural member. Imposing a high enough safety factor to counter this uncertainty simply results in the practical loss of useful life.

An illustrative but not limiting example relates to aircraft frames. The structural lifetime of military and civilian aircraft is ultimately limited by the airframe fatigue life. The precise prediction of the future time of failure is made very difficult because the fatigue crack growth-limited lifetimes can vary by a factor of as much as ten (10) to twenty (20). Imposing a safety factor to account for this variation results in the grounding of many aircraft at times that are far short of the inherent fatigue lifetime in an attempt to limit the possibility of fatigue failure in the theoretically weakest airframe in the fleet.

Prior to about the late 1970's, the design criteria for airframe fatigue life, known as “safe life,” were based on experimentally-derived stress-number of cycles to failure (S-N) curves. This technique used the empirical and experimental approach addressed above, and suffers from the same drawbacks. The assumptions that must be made with regard to the effects of unknown or partially known variables in the service life of the airframe require factors of safety to be enforced on the entire fleet to account for the possible extremes in exposure of some members of the fleet. That is, it must be assumed that not only is every structural element as weak as the weakest element tested, but that each airframe will encounter the worst possible environment with respect to adverse effects on the member.

Designers of military aircraft next adopted a fracture mechanics approach, also referred to as “damage tolerance.” This method is based on measuring the size of existing cracks in a structural element. Predictive calculations based on these measurements are used to estimate the remaining useful life of the element. Many civilian and military aircraft now nearing the specified airframe lifetimes, however, were designed and built prior to the use of fracture mechanics as design tools. Assessing these aircraft now with a view to using fracture mechanics involves a time- and cost-prohibitive evaluation. Moreover, even an exhaustive evaluation cannot determine the stress and fatigue history of the structural elements, which makes any predictive calculations inherently suspect. Moreover, certain variables of interest, such as initial stress resistance and other factors, were simply not measured or calculated for the existing airframes, creating a situation, in which predictions either cannot be made or in which certain variables cannot be estimated. This limitation adds an entirely separate degree of uncertainty to the use of this methodology on existing elements. These aircraft now face premature retirement because there are no tools and methods available to assure continued safe operation with confidence.

The current method of crack growth measurement requires periodic, costly nondestructive evaluation (NDE) of existing airframes and their constituent elements. Concomitant, meticulous record keeping is then required to track trends in crack growth. The current method also suffers from the inherent uncertainties stated above. In addition, these uncertainties are compounded by three known and routinely encountered factors. First, the stress fields of the multiple cracks can and will interact with each other. This interaction makes a determination of a critical crack size, with respect to failure, very difficult. Also, a given structural element is subject to widely varying types and magnitudes of loadings, and in the presence of widely varying degrees of corrosive environments. The compounding nature of these variations makes analytical predictions based on fracture mechanics sufficiently imprecise that, again, large factors of safety are required. These factors introduce variables for which the current methods can only compensate by introducing large factors of safety, or by requiring additional record keeping about loading and environmental exposure. Moreover, it is known that overstress to an element tends to slow, at least temporarily, the rate of crack growth. This feature is analytically difficult inasmuch as there is no means of detecting, predicting, and accounting for either the overstress or the existence and extent of the slowing. Other variables also affect the method, of which the foregoing are well-known examples.

Thus, despite the need for and importance of accurately predicting failure caused by crack growth, existing methods are cumbersome, expensive, and time-consuming. There are also uncertainties for which no adjustment is currently available. Finally, current methods rely in whole or in part on statistical calculations for a set (or class) of elements, rather than for the single element in question. The predictive “window” or interval is thus unacceptably large, leading to structural elements being taken out of service long before the actual end of the useful life thereof. Methodologies providing an improved prediction and thus a higher level of confidence, and apparatus to implement the methodologies, are needed. In addition, methods and apparatus for monitoring individual elements are needed to aid in the task of significantly narrowing the predictive interval of failure.

### SUMMARY

The method, apparatus and system disclosed herein relates to failure forewarning and detection of failure onset in a complex structure under dynamical loading. The method, apparatus and system may be utilized to reduce the labor and material costs otherwise necessary to inspect a complex structure such as, for example, a bridge. The embodiment allows for automatic, continuous and near-real-time failure prediction of a structure. The steps, procedures and/or algorithms disclosed and discussed herein may be implemented by, for example, a laptop or palmtop computer in communication with one or more sensors deployed on or embedded in the structure of interest.

In one embodiment, a method for the nonlinear detection of imminent failure in a complex structural element is disclosed. The method may include the exemplary steps such as: (1) acquiring time-serial weight data from vehicle(s) that cross the bridge via, for example, the method disclosed in U.S. Pat. No. 7,375,293, as a measure of mechanical stress, σ(t), on the structure; (2) simultaneously acquiring time-serial strain, ε(t), data from the bridge structure during the vehicle crossings, as a measure of the bridge's response to the imposed stress from step 1; (3) applying principal components analysis to the σ(t) and ε(t) data, because the data from steps 1 and 2 are complex and cannot be used directly to evaluate the hysteresis strain energy (HSE) over each load-unload cycle; (4) performing the integral, ∫σdε, over each principal component separately through the load-unload cycle to obtain the HSE for that principal component; (5) summing the HSE contributions from each principal component to obtain a total HSE; (6) repeating steps 1 to 5 for many vehicle crossings to obtain a time-serial sequence of HSE over many load-unload cycles; (7) applying, for example, the methodology disclosed by related U.S. Pat. No. 6,460,012 to the data derived from step 6 to determine a forewarning of the structural failure; and (8) providing an indication of the impending failure.

In another embodiment, a method for the nonlinear detection of imminent failure in a complex structural element is disclosed. The method may include sensing stress and strain displacement-related data for said structural element, analyzing the sensed stress and strain displacement-related data as a function of one or more principle components, generating a crack-growth rate function relating said data to for each principle component over a load/unload cycle, determining a total crack-growth rate function based on at least one crack-growth rate function, deriving from said total crack-growth rate function at least one indicator function, monitoring trends in said at least one indicator function, and providing an indication when said monitoring detects an end-stage trend in said at least one indicator function.

In another embodiment, an apparatus for the nonlinear detection of imminent failure in a complex structural element is disclosed. The apparatus includes at least one sensor for sensing stress and at least one sensor for strain displacement-related data for said structural element, and a processor in communication with said sensors. The processor is configured to analyze the sensed stress and strain-related data, generate a net hysteresis-strain-energy from the sum of the hysteresis-strain-energy values for each principle component over load/unload cycle(s), monitor the statistical trend in net hysteresis strain energy, and provide a forewarning indication when said monitoring detects an imminent failure.

In another embodiment, a method for the nonlinear detection of imminent failure in a complex structural element is disclosed. The method includes analyzing stress and strain displacement-related data related to a complex structural element as a function of one or more principle components, determining a total crack-growth rate function based on at least one of the analyzed principle components, wherein at least one indicator function is derived from the total crack-growth rate function, monitoring at least one trend in the at least one indicator function; and providing an indication when the monitoring detects an end-stage trend in the at least one indicator function.

### BRIEF DESCRIPTION OF THE FIGURES

FIG. 1 is a graph showing a typical crack growth curve, with crack length plotted as a function of the number of stress cycles.

FIG. 2 is a graph showing the tri-linear form of a typical fatigue crack growth rate relation for metals.

FIG. 3 is a graph illustrative of hysteresis strain energy plotted as a function of the number of load cycles taken for a sample of aluminum alloy.

FIG. 4 is a table (Table 1) showing fatigue test results for experimental coupons P36-O-45, P36-O-46, P36-O-47, and P36-O-48.

FIG. 5 shows the graphs of experimental data for hysteresis strain energy versus number of fatigue (load) cycles for experimental samples: (a) P36-O-45; (b) P36-O-46; (c) P36-O-47; and (d) P36-O-48.

FIG. 6 shows graphs of the slope of hysteresis strain energy curves for the respective graphs in FIG. 3.

FIG. 7 shows graphs of the curvature of hysteresis strain energy for the respective graphs in FIG. 3.

FIG. 8 shows graphs of the slope of hysteresis strain energy curves for the respective graphs in FIG. 3, with upper and lower control limits.

FIG. 9 shows graphs of the curvature of hysteresis strain energy curves for the respective graphs in FIG. 3, with upper and lower control limits.

FIG. 10 is a table (Table 2) showing experimental results using control limits as an indicator of remaining fatigue life for the samples in Example I, below.

FIG. 11 illustrates an initial stress-strain curve for an aircraft aluminum test coupon subjected to tensile load and strain.

FIG. 12 is a plot of fatigue stress versus deviational strain for the sample used for FIG. 11.

FIG. 13 is a table (Table 3) of the fatigue test results for the aluminum coupon samples discussed in Example II, below.

FIGS. 14-22 are graphs of the input strain energy for samples TM-2 to TM-10, respectively, discussed in Example II, below.

FIGS. 23-32 are graphs of the hysteresis strain energy per cycle versus the number of cycles for samples TM-1 to TM-10, respectively, discussed in Example II, below.

FIGS. 33-42 are graphs showing the slopes of the HSE curves of FIGS. 23-32 with upper and lower control limit functions, as discussed in Example II, below.

FIGS. 43-52 are graphs showing the curvatures of the HSE curves of FIGS. 23-32 with upper and lower control limit functions, as discussed in Example II, below.

FIG. 53 is a table (Table 4) containing data regarding slope and curvature as indications of imminent fatigue failure for aluminum test coupons discussed in Example II, below.

FIG. 54 is a plot of the relative degree of forewarning of failure relative to the position of the failure surface in aluminum test coupons discussed in Example II, below.

FIG. 55 is a sketch of the MSD simulation 2024-T3 coupon used in Example III, discussed below.

FIG. 56 is a table (Table 5) showing fatigue test results for aluminum coupons tested according to Example III, discussed below.

FIGS. 57-64 are plots of the input strain energy versus number of cycles for samples TM2-MDS-1 through TM2-MDS-8, as discussed in Example III, below.

FIGS. 65-72 are plots of the hysteresis strain energy versus number of cycles for samples TM2-MDS-1 through TM2-MDS-8, as discussed in Example III, below.

FIGS. 73-80 show the slope functions of the HSE functions in FIGS. 65-72 with upper and lower control limit functions, as discussed in Example III below.

FIGS. 81-88 show the curvature functions of the HSE functions in FIGS. 65-72 with upper and lower control limit functions, as discussed in Example III below.

FIG. 89 shows the data curves for a tension-tension test of an aluminum coupon treated to simulate multiple site damage and corrosion, the curves showing: (a) the input strain energy; (b) the hysteresis strain energy (HSE); (c) the slope of the HSE curve, with upper and lower control limit functions, and (d) the curvature of the HSE curve, with upper and lower control limit functions.

FIG. 90 shows the data curves for a tension-tension test of a notched aluminum coupon, the curves showing: (a) the input strain energy; (b) the hysteresis strain energy (HSE); (c) the slope of the HSE curve, with upper and lower control limit functions, and (d) the curvature of the HSE curve, with upper and lower control limit functions.

FIG. 91 shows the data curves for a tension-tension test of a corroded, unnotched aluminum coupon, the curves showing: (a) the input strain energy; (b) the hysteresis strain energy (HSE); (c) the slope of the HSE curve, with upper and lower control limit functions, and (d) the curvature of the HSE curve, with upper and lower control limit functions.

FIG. 92 is a table (Table 6) comparing the fatigue data for a corroded, unnotched aluminum coupon (Sample SM-TN-AL-CO—CS-UN-1 from Example IV below) with the data from Example II (Table 4 in FIG. 53.

FIG. 93 shows plots of stair step fatigue amplitude for an uncorroded, unnotched aluminum coupon as described in Example IV below, the data showing (a) ISE and (b) HSE.

FIG. 94 shows the data curves for a tension-tension Mode I crack growth test of a tapered ASTM A-36 steel cylindrical, corroded and notched as described in Example IV, the curves showing: (a) the input strain energy; (b) the hysteresis strain energy (HSE); (c) the slope of the HSE curve, with upper and lower control limit functions, and (d) the curvature of the HSE curve, with upper and lower control limit functions.

FIG. 95 is a plot of changes to stored strain energy versus logarithmic time under load, and the slope thereof, for a notched, uncorroded aluminum coupon as described in Example V, below.

FIG. 96 is a plot of changes to stored strain energy versus linear time under load, and the slope thereof, for a notched uncorroded aluminum coupon as described in Example V, below.

FIG. 97 is a plot of changes to stored strain energy versus logarithmic time for a notched corroded aluminum coupon as described in Example V, below.

FIG. 98 is a plot of changes to stored strain energy versus linear time for a notched corroded aluminum coupon as described in Example V, below.

FIG. 99 is a plot of the slope of the curve shown in FIG. 98.

FIG. 100 is a plot of the curvature of the curve shown in FIG. 98.

FIG. 101 is an expanded plot of the curve in FIG. 97, showing the entirety of the data set for the test described in Example V, below.

FIGS. 102 and 102A are flowcharts of the analysis process utilized to detect imminent structural failure in a complex structure.

### DETAILED DESCRIPTION

It is known that under normal conditions, i.e., in the absence of a catastrophic event, the ultimate failure of a structural element due to loading and/or corrosion is the result of the appearance and growth of cracks in the element. At some point, the number and extent of cracks weaken the element sufficiently that failure occurs. For a given element, the point of failure can be measured by testing the element to destruction. While such testing cannot be applied to an element in actual use, the destruction of the element being that which is to be avoided, the testing of a sufficient number of elements can provide a statistical model for predicting a point of failure.

Using such a statistical model has severe drawbacks. For the sake of safety, the predicted useful life of a structural element must be limited to the lowest, or earliest, boundary of the statistical point of failure. Thus, the effective useful life of a set of elements is limited to the weakest one of such elements, because to exceed this boundary risks the failure of some number of the set. This is costly, inasmuch as many, and perhaps the majority of the elements, could safely remain in use for a longer time.

The use of such a model also entails the use of costly and time-consuming NDE to compare the condition of a given structural element to the model. Moreover, the model cannot reasonably and reliably predict in advance the occurrence of the problems set forth above, e.g., multiple cracks, to allow an a priori prediction of useful lifetimes for individual structural elements without again requiring large safety factors.

It is thus a goal to develop a method and apparatus that overcome these problems and uncertainties. It is likewise a goal to enable monitoring of crack growth and growth rate in a given structural element. It is also a goal to find and utilize some characteristic of the crack growth itself to predict impending failure of the specific element in question with a high degree of reliability. Rather than relying on group statistics inherently having weakest and strongest members, predictions can be made based on each individual element. The method and apparatus disclosed herein achieve these goals.

For example, one method to achieve the desired goals may involve the steps: (1) acquiring the time-serial value of mechanical stress, σ(t), on the structure element via an embedded sensor; (2) simultaneously acquiring time-serial strain data, ε(t), from the same element via another embedded sensor as a measure of the structure's response to the imposed stress from step 1; (3) applying principal components analysis to the σ(t) and ε(t) data, because the data from steps 1 and 2 are complex and cannot be used directly to evaluate the hysteresis strain energy (HSE) over each load-unload cycle; (4) performing the integral, ∫σdε, over each principal component separately through the load-unload cycle to obtain the HSE for that principal component; (5) summing the HSE contributions from each principal component to obtain a total HSE; (6) repeating steps 1 to 5 for many load-unload cycles; (7) applying, for example, the methodology disclosed by related U.S. Pat. No. 6,460,012 to the data derived from step 6 to determine a forewarning of the structural failure; and (8) providing an indication of the impending failure.

Cracks and crack growth in structural elements are broadly due to loading, corrosion, or both. Cracks and crack growth due to regularly or irregular dynamic loading is referred to herein as fatigue cracks and fatigue crack growth, respectively. Damage due to a constant loading in the absence of corrosion is referred to as creep. Creep crack growth is a form of crack growth wherein viscous flow under static loading occurs at the crack tip, leading to time-dependent crack growth. Crack growth that is predominantly due to corrosion of an element under static loading is referred to as stress corrosion. The corrosion preferentially attacks the material under high stress at the crack tip, leading to crack extension in a time-dependent fashion.

Structures can be loaded in three ways. These are termed tension, flexure, and shear. Cracks and crack growth caused by these loadings can extend in three ways or modes. There is an opening mode referred to as Mode I created by tensile or flexure forces. The in-plane shear mode (Mode II) is due to in-plane shear forces, and out-of-plane shear mode (Mode III) is due to out-of-plane shear forces such as torsion. The method and apparatus disclosed herein are applicable to all three modes of crack extension where subcritical crack growth occurs prior to final fracture or failure.

Corrosion can be caused by a variety of environmental factors. Examples of corrosives are salt, such as in structures exposed to sea water, and pollutants such as oxides of sulfur. Corrosion itself causes crack growth. In structural members also subject to the forces identified above, corrosion is usually observed to exacerbate the crack growth caused by such forces.

A combination, or all, of these load, stress, and corrosion factors may influence crack growth. A structural member may be under a constant load and also subject to a periodic increase or decrease in load. A member or element subject to periodic loading may also be exposed to a corrosive environment. Typically, one cause of crack extension or growth predominates.

### I. DETECTION OF IMMINENT STRUCTURAL FAILURE IN SIMPLE STRUCTURES

Without limiting the scope of the claims, the disclosure provided herein is applicable in its preferred embodiments to the following primary modes of crack extension: (a) fatigue crack growth, due to dynamic loads in the absence of creep and corrosion; (b) corrosion fatigue crack growth, due to the combined effects of dynamic loads and corrosive environments; (c) creep crack growth, due to steady loads in the absence of corrosion; and (d) stress corrosion crack growth, due to the combined effects of dynamic stress and a corrosive environment.

Fatigue and corrosion fatigue crack growth can be considered together, with creep crack growth and stress corrosion crack growth each requiring slightly differing manipulations of data.

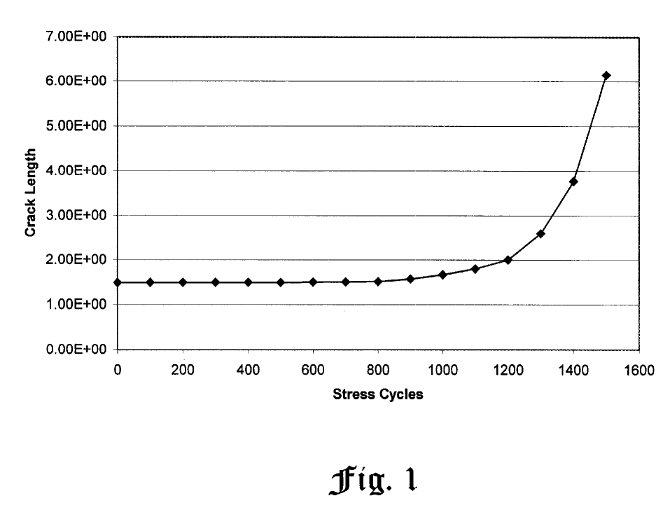

The typical crack growth relationships are generally known, and are applicable to a wide variety of materials subject to failure due to crack growth. These materials include, among others, metal and metal alloys and fiber composites. A typical crack growth curve for metals is illustrated in FIG. 1. This graph shows crack length as a function of the number of alternating load or stress cycles. It shows that crack length as a function of cycles remains very low for the majority of the useful life of the material. The length then exhibits a significant perturbation, in this case, a significant upward rise.

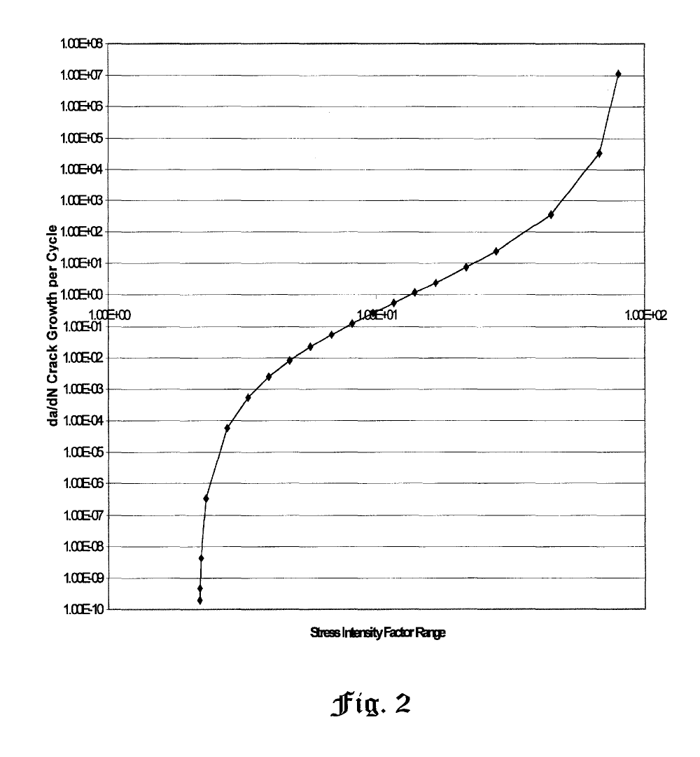

Crack growth per cycle can be plotted as a function of the stress intensity factor range, as is illustrated in FIG. 2. This relationship exhibits an initially high rate of growth. The rate then “plateaus” to a relative degree, after which there is again observed a significant perturbation in the growth rate. The growth rate curve, in its nominal form, is thus an essentially tri-linear curve. For many materials, there is exhibited an initial drop in the rate (not shown in FIG. 2 due to plotting scale) prior to the initial rise.

Monitoring crack length or area, crack growth, or crack growth rate as direct physical phenomena, however, requires time-consuming and expensive evaluations such as those referenced above. Such monitoring also requires meticulous record keeping, and does not eliminate the need to use broad statistical models for predicting end of life or the close approach thereto.

Related and incorporated U.S. Pat. No. 6,460,012 discloses an exemplary method to predict structural failure on the basis of the energy invested in crack growth. This energy, referred to generically herein as (hysteresis strain energy) HSE, is then calculated as a function of a load cycle interval or a time interval. An indicator function, to be used as described below, is derived from HSE. The energy that is related to crack growth and crack growth rate are extracted from this curve by means of a nonlinear filter, a preferred one of which is set forth below. The filtered data can then be used as an indicator function to determine the onset of the final stage trend, that is, the onset of final-stage crack growth. The onset of this trend is a reliable indicator of the imminent onset of failure in the element. The testing and demonstrations disclosed and discussed in connection with U.S. Pat. No. 6,460,012 utilized “dog-bone” test coupons under laboratory-controlled test conditions. Consequently, the present disclosure relates to a system and method to predict structural failure in large, complex structures under arbitrary loading.

The HSE function, after filtering, can itself be used to detect trends. In a preferred mode, the HSE slope function, HSE curvature function, or both, are obtained from the HSE. Either or both of these functions can be used directly as the indicator function to be monitored to detect trends. Alternatively, one or more limit functions can be derived from the HSE function and/or the slope function and/or the curvature function, and these limit functions can be used in conjunction with the indicator functions to detect the desired trends. Apparatus for implementing the method are also disclosed.

The disclosure encompasses the use of HSE, and the nonlinear analysis thereof as described, as an accurate means of monitoring crack growth and growth rate in a material subject to fatigue and corrosion fatigue crack growth. For these types of crack growth, the disclosure further encompasses a means for using HSE to accurately detect the approach of failure due to crack growth. For creep crack growth, the disclosure encompasses the use of load- and strain-related data as a logarithmic function of time to monitor crack growth in structural elements subject to a constant load. Load- and strain-related data as a linear function of time enables the monitoring of crack growth in elements subject to stress corrosion.

Methods and apparatus for the real-time or near real-time monitoring of materials are provided thereby. The methods and apparatus are generally applicable to predicting the approach of the final stages of crack dominated failure in structures and structural elements, whether such cracks are the result of fatigue generated by loading cycles or are the result of time dependent changes in strain energy in creep crack growth or stress corrosion assisted crack growth.

In general, crack initiation and growth require energy consumption. This energy for crack growth, along with other forms of energy consumption internal to the structural member, is supplied as external energy by the application of dynamic or static external loadings, and/or by concomitant corrosion. When other forms of internal energy consumption are sufficiently low compared to the energy consumed by crack growth, then HSE (for fatigue and corrosion fatigue) or other load- and strain-related data can be appropriately measured or calculated and used as a representation of crack growth.

HSE can be appropriately measured or calculated and used as a representation of crack growth. HSE is plotted as a function of (1) the number of loading cycles for an element subject to loads or (2) predetermined time segments for an element subject to constant load or to stress corrosion, to generate a strain or HSE curve. As referred to herein, a loading cycle with respect to regularly or irregularly dynamic loading is the interval between (i) a local maximum load value through a local minimum value to the ensuing maximum (max-min-max) or (ii) a local minimum through a local maximum to the ensuing minimum (min-max-min). The predetermined time segment can be measured by any clocking means.

According to the method of the disclosure, HSE is calculated from data obtained in well-known ways. For structural elements made of metals and metal alloys, devices such as tensiometers, extensometers, strain gauges, and displacement sensors will provide stress and strain data. Similar devices can be used to measure changes in load and strain as a function of time. For materials such as composites, embedded sensors may be used.

One sensor well-suited for composites consists of embedded optical fibers. The light transmission quantities for the embedded fibers will change as cracks develop. Crack growth will change the length or curvature of the fibers, or will break the fibers. The light transmission thus serves as a measure of crack growth. The fibers may thus be used to measure strain as disclosed and described in related U.S. Pat. No. 4,191,470; to measure pressure as disclosed and described in related U.S. Pat. No. 4,770,492; and/or load as disclosed and described in related U.S. Pat. No. 4,421,979.

The advantage of embedded sensors, and particularly sensors such as light fibers, is the novel ability to measure data over a broad area and/or throughout a volume, rather than at a point source. Using these sensor technologies, which may be expanded beyond use in composites, provides a means of creating novel “smart” structural elements, wherein the element itself contains the sensors and data can be obtained directly therefrom. By sensing areal and/or volumetric data, the determination of crack growth and crack growth rate is both more comprehensive and more reliable.

For fatigue and corrosion fatigue crack growth, the load and strain or displacement data are integrated over the load cycle to determine HSE. The calculation is a loop integral function. The load cycle is determined by comparing the physical data to a clock output to determine the selected min-max-min or max-min-max cycle described above. For creep crack growth and stress corrosion crack growth, the load- and strain-related data are integrated over a time interval, providing a measure of energy consumption for the time interval. Energy consumption, whether measured as HSE or as the time-dependent change, serves as the measure of crack growth.

The foregoing calculations are performed by a processor operatively connected to the data measuring devices described. Processors capable of performing the described integrations, and the calculations further described below, are known in the art. The processor may consist of dedicated circuitry designed to perform only the necessary calculations, or can be a general purpose processor or computer programmed to perform the calculations. The clock can be associated with the structural elements and/or the sensors, or can be part of the processor.

For each type of crack growth, the processor calculates HSE values. An HSE curve is then plotted. For fatigue and corrosion fatigue, HSE is plotted as a function of the number of load cycles. For creep, HSE in the form of the integrated load- and strain-related data is plotted as a function of time, and for stress corrosion, HSE in the form of integrated load- and strain-related data is plotted as a function of time on a logarithmic scale. The resulting curve is referred to as the HSE curve.

It is theoretically possible, and within the scope of this disclosure, to analyze this HSE curve itself to determine when crack growth has shifted into a new phase (secondary or tertiary), the shift being the indication of imminent failure. Practically, however, there are many independent variables experienced in use. Also, there is the effect of variations in HSE caused by differences, for example, in load amplitude and frequency, in material, and in other factors affecting the HSE values. These create a level of “noise” in the curve that severely and negatively affects the usefulness of the HSE.

The inventors hereof have discovered that by applying a novel, zero-phase quadratic filter to the HSE curve, the HSE curve can be smoothed and made useful. The HSE curve after smoothing provides general trends, from which improved forewarning can be obtained by examining the slope and/or curvature of the HSE curve. While either value alone is useful in predicting end-phase crack growth, the preferred embodiment of the disclosure utilizes both the curvature and the slope values.

Because of the low-amplitude variation in the HSE curve, the curvature and slope values also exhibit random variations that must be distinguished to achieve accurate predictions. This distinction is achieved by treating the values of the slope and curvature as statistical variables. This is similar to the construction of an industrial process control chart.

The slope and curvature functions can be used for detecting trends, and especially the end-phase trend in crack growth rate that indicates the imminent EOL for the structural element. A preferred method for monitoring trends in the slope and curvature functions is to establish limit functions that can be compared to the slope and curvature functions to determine the onset of a trend. For each set of slope values and curvature values, an upper control limit (UCL) and lower control limit (LCL) are established. These limits are calculated as the mean value of the slope or curvature plus or minus, respectively, a predetermined multiple of the calculated standard deviation of the corresponding slope or curvature, respectively. These two pairs of curves, that is the slope with its UCL and LCL and the curvature with its respective UCL and LCL, can be recorded and monitored in any convenient manner including but not limited to graphically (e.g., by trace), visually (e.g., on a monitor), and/or as electronically stored data (e.g., as RAM or on magnetic tape).

It has been discovered by the inventors hereof that a reliable and accurate predictor of imminent failure is a statistically significant perturbation in the curvature and/or slope values. That is, failure can be considered imminent at a point at which either the slope or the curvature values intersect with either the UCL or LCL curves.

The foregoing is detailed as follows. While this explanation is specific to the case of fatigue crack growth and corrosion fatigue growth, it is equally applicable to creep crack growth and stress corrosion, as will be seen by those of skill in the art. That is, the method is applicable to crack growth as represented by the energy consumed by crack growth as defined above.

Griffith introduced the technique of considering crack growth in solids as a process of energy exchange, in which external energy is introduced and stored as internal strain energy. During the process of crack growth, which is an energy consuming process, the internal strain energy and any additional externally introduced energy from loading is transformed into new crack surface area. When the rate of change of internal strain energy per unit crack length equals the rate of consumption of surface energy due to additional crack surface creation, a crack will begin to extend. This critical strain energy release rate, called G_{lc}, then becomes a criterion for the onset of initial crack extension. The subscript I indicates Mode I crack growth, as defined above, and the technique is also valid for the other two Modes II and III of crack growth.

This technique has been extended by Rice to elastic-plastic materials through the introduction of a nonlinear-elastic version of the same criterion, denoted as J_{lc}. The method applies Green's theorem to nonlinearly-elastic loaded structures to express the sum of changes in internal strain energy plus changes in externally supplied energy due to crack growth. When the sum of these changes equals the surface energy of the material, a crack will begin to extend.

Criteria for the onset of crack growth in creep, or sustained loading of cracks, and in stress corrosion cracking (K_{lcc}, J_{lcc}) have been measured for various materials as material properties similar to G_{lc} and J_{lc}.

From linear elastic fracture mechanics, the Griffith energy for crack extension is numerically equal to

$${G}_{c} = {K}^{2} / E = \frac{d U}{d a} \qquad ( Equation 1 )$$

where G_{C} is the critical strain energy release rate, K is the stress intensity factor, E is Young's modulus, U is the potential energy (strain energy) available for crack extension, and da is the incremental crack extension.

During fatigue, dU is the change in strain energy per cycle. Assuming that this change in strain energy contributes to crack growth then, for fatigue crack growth, this represents the hysteresis strain energy per cycle. Where N is the cycle number, fatigue crack growth rate per cycle is da/dN. If this is multiplied by the constant critical strain energy release rate for the material dU/da, then

$$( \frac{d a}{d N} ) ( \frac{d U}{d a} ) = ( \frac{d U}{d N} ) \qquad ( Equation 2 )$$

Substitution of Equation 1 into Equation 2 provides an expression for da/dN:

$$\frac{d a}{d N} = \frac{( \frac{d U}{d N} )}{{G}_{1 C}} \qquad ( Equation {2}^{′} )$$

Equation 2′ means that the quantity of HSE consumed per cycle is linearly related to the quantity of crack growth rate per cycle and, when plotted, produces a curve that shifts from the fatigue crack growth rate curve.

During fatigue, crack growth typically occurs in three distinct phases. These are nucleation (crack initiation), stable crack growth (subcritical crack growth), and unstable final crack growth. It is the onset of the final stage that serves as an indicator of imminent failure, and the detection thereof therefore allows full use of the element without risking failure.

The foregoing is then applied as follows. The work consumed by the structural element under load is the force-through-distance energy, integrated over the work cycle. As indicated above, the “work cycle” can be a time interval. In the following, the work cycle is a load cycle.

The force in this case is the applied load, P. Elongation under load, measured for example as displacement in a critical region of the element, is δ. The input strain energy for each cycle is

E₁ₙ=∫Pdδ (Equation 3)

over the loading portion of the cycle, where the integral is from PMIN to PMAX. The HSE subtracts the strain energy over the unloading part of each cycle from Equation 3. HSE is then computed as the loop integral:

$$E = ∮ P d δ \qquad ( Equation 4 )$$

Equation 4 is an expression for the net energy change per cycle, dU/dN. Consequently, Equation 4 can be substituted into Equation 2′ to yield an expression for the crack extension per cycle, da/dN:

$$\frac{d a}{d N} = \frac{∮ P d δ}{{G}_{1 C}} \qquad ( Equation {4}^{′} )$$

Equation 4′ means that the crack-length extension over a load-unload cycle is directly proportional to the HSE. Consequently, it is sufficient to analyze HSE alone, because all of the HSE results are simply scaled by the proportionality factor, (1/G_{1C}).

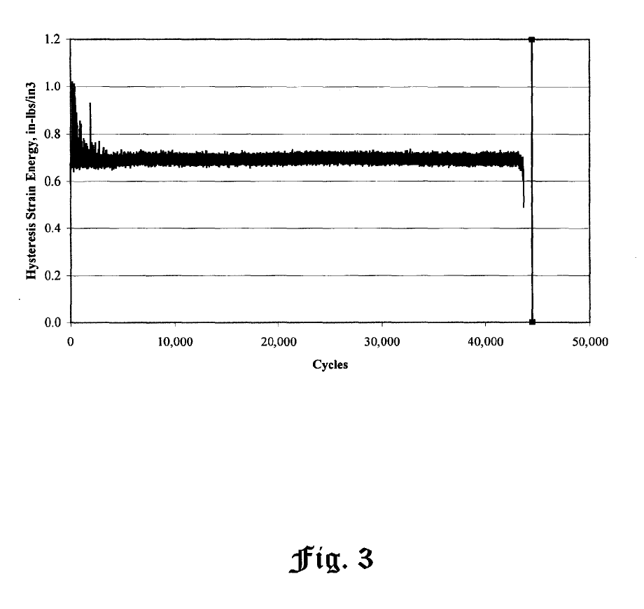

The HSE, E, is a function of the number N of applied loading cycles and is variable as shown in FIG. 3, which depicts HSE for an experimental sample. HSE, as well as other load- and strain-related data, depends on load amplitude and the material. The noise tends to mask trends in HSE that would indicate, for example, the onset of final stage unstable crack growth. When the noise level is high, E alone, or local trends therein, cannot be used to detect the imminent onset of failure.

To overcome the masking of trends by noise, smooth trends are extracted with a novel, zero-phase, quadratic filter as is set forth in U.S. Pat. No. 5,626,145 to Clapp et al., assigned to the assignee of the current disclosure, incorporated herein by reference. This filter uses a moving window of 2w+1 points of E(N) data, with the same number of data samples w on either side of the central point. The trend y at the central point of this window is estimated from a least-squares fit of the 2w+1 points to a quadratic curve. Adequate smoothing is achieved with a window width of 2w=about 5% of the total number of loading cycles. The trend then has the form:

y(z)=az²+bz+c (Equation 5)

In Equation 5, z=N−n, where n is the fixed value of the number of loading cycles associated with the central point in the filter window with N≧2n+1. The corresponding value of y(z) at the central point of the window is

y(z=0)=c (Equation 6)

By applying this zero-phase, nonlinear filter to the HSE curve, a smoothed HSE curve is obtained. Low-amplitude noise resulting from other forms of energy consumption is reduced, and the smoothed HSE curve more clearly reflects trends relating to crack-growth rate.

The foregoing filtering and fitting, with the necessary derivations, are accomplished by a processor receiving as input the values for the HSE curve. As with the other processors used in the method and apparatus of the disclosure, the processor performing the foregoing functions may be dedicated circuitry or may be a programmed general purpose processor. Also as stated above, the processor for the extraction of trends from the HSE curve may be a separate unit operatively connected to other processors, or all of the processors may be integrated into or as a single unit.

The typical crack growth rate curve as shown in FIG. 2 for a metal shows an initial trend. The growth rate then enters a region of fairly steady state, stable subcritical crack growth. The curve then enters a third distinct stage, indicating unstable final stage crack growth. Entry into this third stage is taken as the detection of the imminent end of life for the structural element. Thus, the crack growth rate curve itself can be used as an indicator function for impending failure. The HSE curve represents energy consumption due to crack growth, which superimposes on other modes of energy consumption, the final stages of which become noticeable when HSE due to crack growth becomes large enough to exceed the background damping level of energy consumption. Failure onset is then observed as an excursion above or below the constant trend in HSE. The nonlinear filtering, such as that set forth above, is intended to extract the noise-free crack-growth rate function from the HSE curve, thus excluding noise created by other forms of energy consumption and the inherent noise in sensor data.

Even after smoothing, however, the HSE curve may be too noisy to be a reliable indicator. While it is within the scope of the disclosure to use the HSE curve itself as an indicator function, it has been found that the slope, curvature, or both the slope and curvature provide a highly reliable indicator function of end-stage crack growth. The slope and curvature values can be derived from the smoothed HSE curve after filtration as set forth above. The slope at the central point of the moving window is

y′(z=0)=b (Equation 7)

The second derivative at the central point of the window is

y″(z=0)=2a (Equation 8)

The curvature of the curve y(z) is defined as

$$κ = \frac{{y}^{″}}{{[ 1 + {( {y}^{′} )}^{2} ]}^{\frac{3}{2}}} = \frac{2 a}{{[ 1 + {b}^{2} ]}^{\frac{3}{2}}} \qquad ( Equation 9 )$$

Even with the smoothing and filtering step described, however, the slope and curvature values derived for the HSE curve still exhibit low-amplitude variation. This variation can still tend to mask the trends in crack growth, as measured by the trends in the HSE curve. In certain applications, depending on the structure in question, the filtering step may be repeated. Too many repetitions, however, will of course smooth the very trends being sought.

In a preferred mode of the method, therefore, a subsequent processing step is undertaken to distinguish random variations in the HSE curve, and the values for the curvature and slope thereof, from the systematic trend toward unstable final stage crack growth, the latter being the indication used to detect failure onset. This step encompasses establishing one or more limit values or limit functions. A further processing step is undertaken to derive the desired limit functions.

The limit functions are calculated by treating the values of the slope and curvature functions as statistical variables. This step is similar to that for which an industrial process control chart is constructed. The step begins with deriving x denoting the sample mean, computed from the beginning of the data xᵢ for the current cycle. This value is

$$\underline{x} = {\sum }_{i} \frac{{x}_{i}}{N} , i = 1 , N \qquad ( Equation 10 )$$

The corresponding standard deviation estimate s is then obtained from

$${s}^{2} = {\sum }_{i} \frac{{( {x}_{i} - \underline{x} )}^{2}}{N - 1} , i = 1 , N \qquad ( Equation 11 )$$

Using these calculated values, one or more limit functions can be calculated for comparison with the selected indicator function. In a preferred mode of the disclosure, both an upper control limit function (UCL) and a lower control limit function (LCL) are calculated. Preferred values for these functions are

UCL=x+4s (Equation 12)

LCL=x−4s (Equation 13)

Using these values, the UCL and LCL, or either, can be plotted as limit functions for comparison to the selected indicator function. According to the method of the disclosure, the indication of failure onset for the structural member is then the point at which the indicator function, preferably the slope or curvature functions or both, exceeds the UCL positively or the LCL negatively. The detection of imminent failure can be set as this point of exceeding, the point of intersection of the indicator and limit functions, or a defined point of approach of the indicator and limit function curves. Any of these points, generally referred to herein as the convergence of these functions, can be selected as the indication of failure onset.

The selection of the multiple for the standard deviation value swill depend on the material, the environment, the desired safety factor, and other considerations. The multiplier of 4 used above will establish limits wherein the probability of Gaussian random data exceeding one or the other of the limits corresponds to a false positive probability of 1 part in 31,574 independent and identical distributed measurements. The multiple can be adjusted to give the desired probability of false positive or negative indications based on the expected number of cycles or intervals to failure. The multiplier for the UCL and LCL may be the same or different.

Other variations are also possible. For example, the window 2w+1 used in the filtering and fitting step may be narrowed or broadened. A narrower window will allow quicker detection of failures. These events may be of interest in certain research applications or where safety concerns are high enough. A narrower window will lessen the smoothing function, and may mask the onset of trends. A broader window, on the other hand, may be desired where local phenomena are of little concern. This greater smoothing, however, may also affect the detection of trends by smoothing and thus effectively eliminating the early indications of trend changes. Experimental work indicates that the 5% of useful life window generally avoids both of these possible problems.

The method of the disclosure thus encompasses the calculation of this limit function(s) and the monitoring of the limit and indicator functions. An indication is provided in the form of an output signal, which may be of any desired form. The output may, for example, trigger an alerting mechanism such as an indicator light, an audible warning, or the like. Alternatively, the output may be simply graphic or numeric in form, providing data from which a decision on continued use of the element may be based.

The HSE curve itself can be used as the indicator function for any of the three defined classes of crack growth, that is, fatigue and corrosion fatigue crack growth, creep crack growth, and stress corrosion crack growth. Because of the low-amplitude noise, as mentioned, the detectable trends in this curve do not always provide a reliable indicator of the final-stage trend. Deriving the slope and/or curvature functions, as shown, provide better indicator functions. The choice of which indicator functions, or which combinations thereof, to use as the primary indicator function will depend on factors such as the material, the environment, and the type of structural element.

Each derivative of the initial HSE curve increases the effect of the noise in the HSE curve. Therefore, in some applications, it may be useful when calculating the slope and curvature functions to use the zero-phase quadratic filter described above to smooth these derived curves. Even when these functions are smoothed, some noise remains. Thus, while monitoring these functions alone to detect the onset of final stage crack growth may suffice in some applications, it is preferred that the limit functions be established to provide a more accurate and reliable indication of this final stage.

The apparatus by which the method can be accomplished can vary widely. Many different types of sensors can be used to measure load, strain, and displacement in critical areas of the structure. These sensors may be associated with, adhered to, or embedded in the structure. The output of the sensors may be stored for periodic evaluation, or may be processed and monitored in real time. The clock necessary to determine load cycles and time intervals is also well-known. Also as described, the processor is utilized to: acquire the sensor data, perform principle-value decomposition; perform the integral over each load-unload cycle or time interval to obtain the HSE for each principle component; sum HSE over the principle components; apply the zero-phase quadratic filter to extract the HSE slope and HSE curvature; compare the HSE slope and HSE curvature to the upper and lower control limits; and provide an indication of failure forewarning when these limits are exceeded. The processor may be separate interconnected units or a single integrated processor. The forewarning indication may be any audio or visual device, or a graphical or numerical display.

The foregoing description used fatigue and corrosion fatigue crack growth as an example, where the crack growth is monitored by measuring and calculating HSE. The description applies equally to monitoring crack growth where creep or stress corrosion effects predominate. For each of these, the sensors provide stress and/or strain data, which is then plotted as a function of time. The load and strain data is integrated over the selected time interval to measure the change in energy over the time interval. The change in energy is a measure of the crack growth, as before. The result is the HSE value, which is appropriately plotted as a function of time.

Having calculated the value of HSE, as used herein, for creep crack growth rate, it is preferred to express it as a logarithmic function of time. The curve thus plotted shows the same trilinear curve as the typical crack growth rate curve for metals. This approach clearly indicates the change in HSE. In the case of creep crack growth, there are not the competing mechanisms of damping found in fatigue crack growth to mask the lower portions of the creep crack growth rate curve. Thus, the creep crack growth rate curve exhibits an appearance similar to the full fatigue crack growth rate curve for metals.

For stress corrosion, it is preferred to express the HSE values as a linear function of time. For stress corrosion, this plot will also assume the trilinear form of the typical curve. Applying the nonlinear filter will clarify even further the resulting function, making detection of the end-stage crack growth a reliable indicator of imminent failure.

The relevant processors may be programmed to plot in any desired fashion, so long as the trends are clear and ascertainable as described above. A given structural element will likely be subject to both creep and stress corrosion effects, with one or the other predominating during differing periods in the life of the member. In utilizing the method and apparatus of the disclosure in such situations, the HSE (along with corresponding changes in HSE) can be plotted as a function of both logarithmic and linear time, with appropriate monitoring of the trends, such as by limit controls. The output signal as an indication of imminent failure would then be given when the trend is detected on either the logarithmic or linear scales. When using control limit functions, a forewarning indication occurs when either HSE slope or HSE curvature exceeds the appropriate limit function.

Several tests were conducted to illustrate the use of the foregoing methodology. In each of the following, the various steps used in deriving HSE values, indicator functions and limit functions are as described above.

### II. EXAMPLE I

Four coupons of randomly oriented fiber-reinforced plastic were tested. The coupons were nominally ⅛ inch thick and were machined to a reduced cross-sectional shape with a 1.6 inch gage section for a 1.0 inch extensometer.

Three data variables were recorded: displacement of the loading grips, tensile load, and tensile strain in the reduced section as measured by the extensometer. Loading was performed at room temperature on a servohydraulic test machine having a 10,000 pound capacity. The fatigue loading frequency was 10 Hz. Data were recorded by a National Instruments PCI 16XE-50 General Purpose I/O System of 16-bit resolution. The data recording frequency was 2,000/channel/second, producing about 200 measurements of each variable over each fatigue cycle. Load cell voltage variations were on the order of 0.1% (10 mV) of full scale (10 V), or 10.0 pounds. Measurement resolution was 1.0 pound in load measurement (about 10 psi) and 5 μ∈in strain measurement.

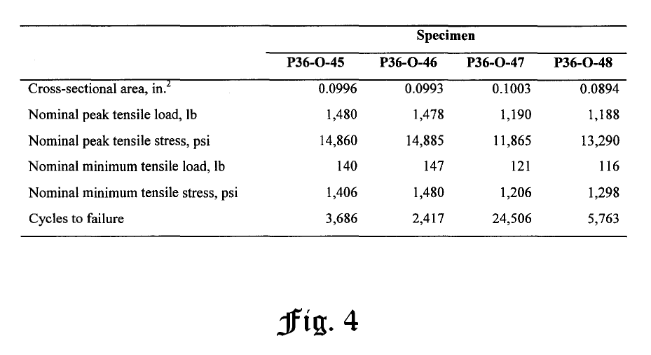

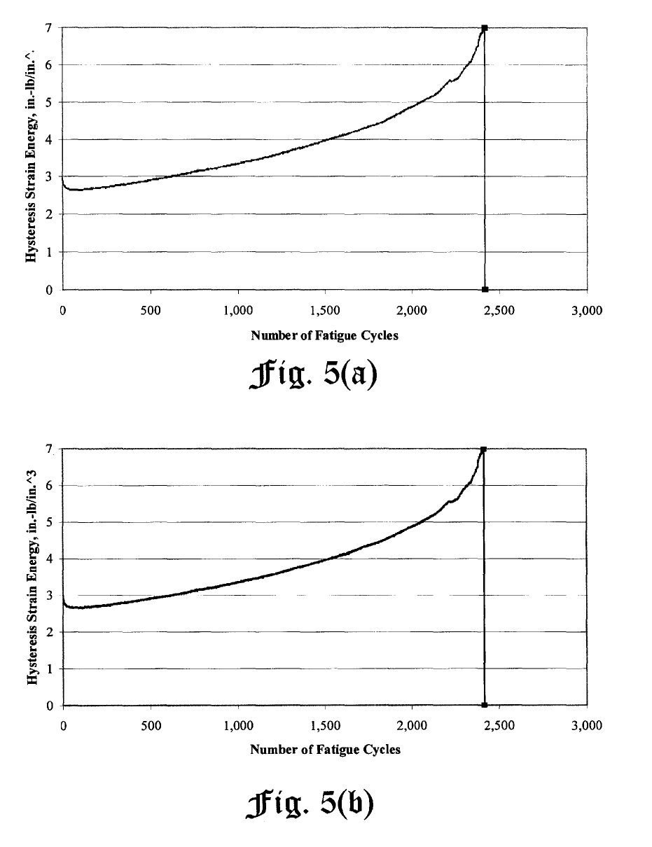

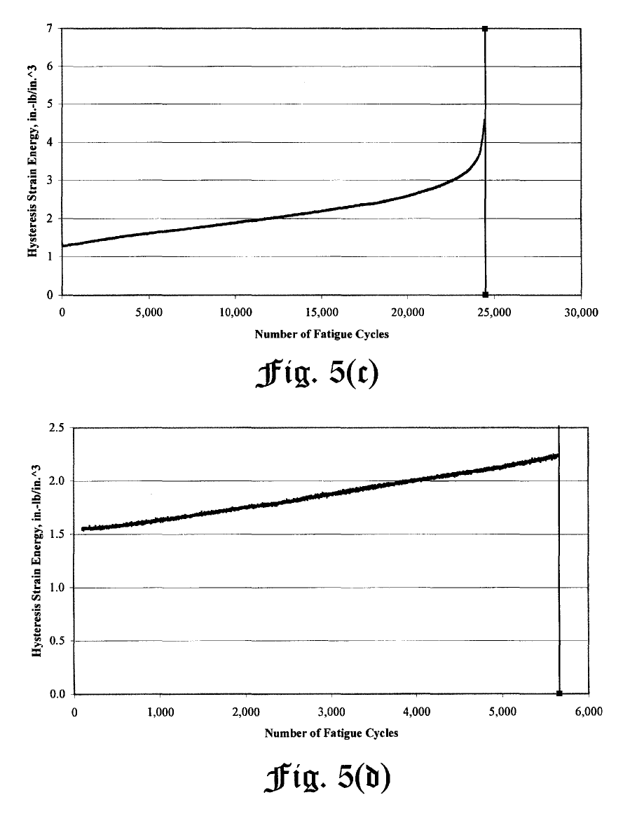

The fatigue test results for the four coupons, designated as P36-O-45, P36-O-46, P36-O-47, and P36-O-48, are shown in Table 1 in FIG. 4. The hysteresis strain energy data for the coupons was plotted as a function of the number of load cycles as shown in FIG. 5, wherein in each graph the point of failure is shown by the vertical bar. The data show that the initial hysteresis strain energy consumption per fatigue, or load, cycle was approximately 1.5 to 3.0 in-lb./in³. The energy consumption shows an initial sharp decrease, followed by a monotonic rise, and finally followed by a sudden rise near failure.

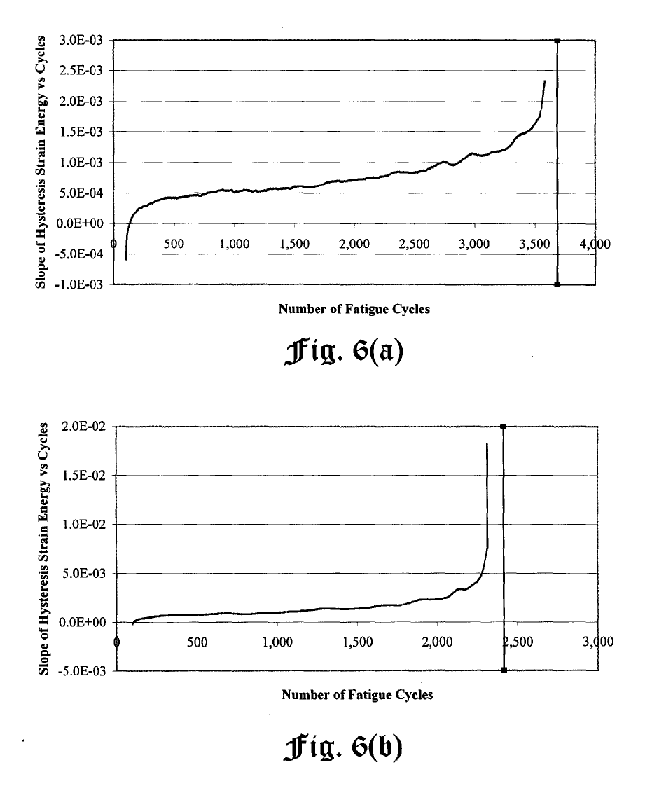

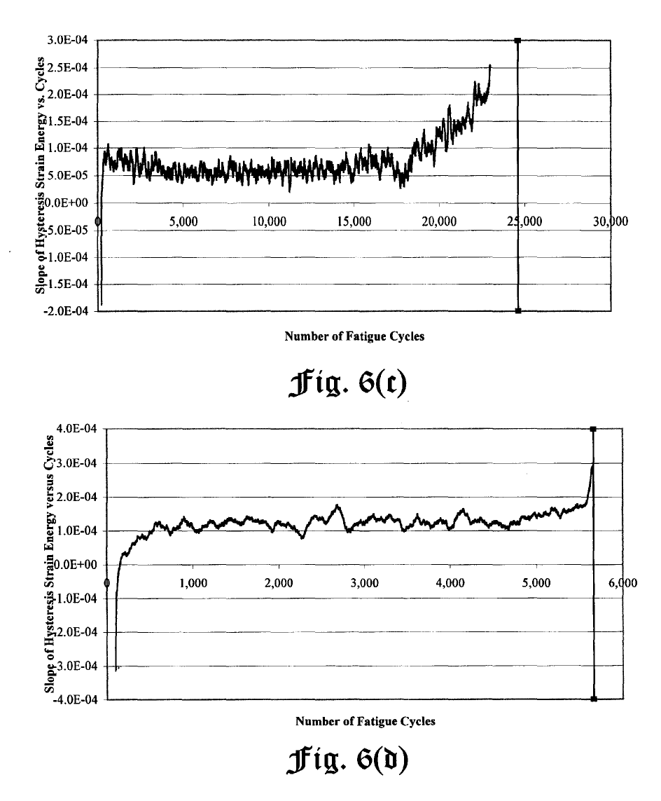

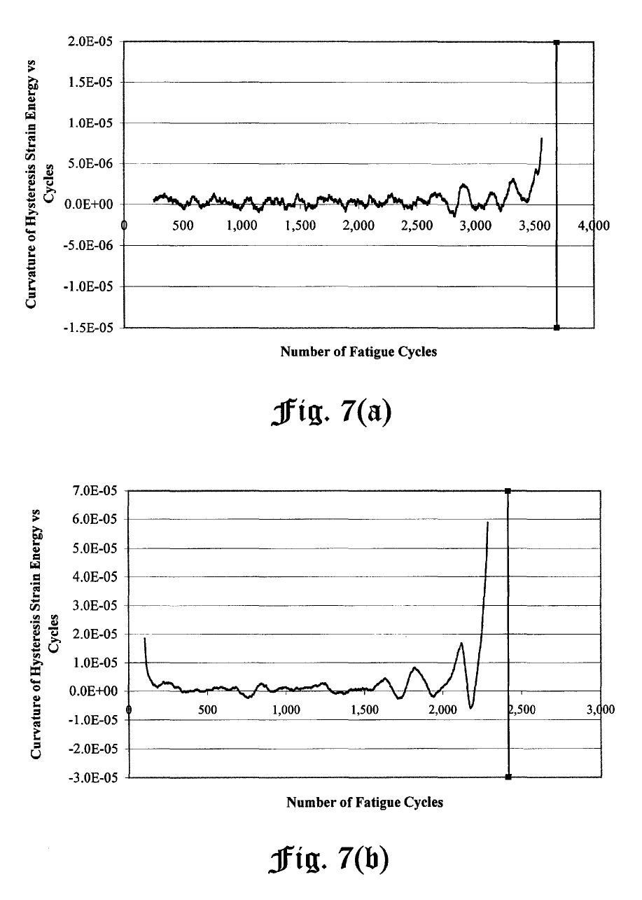

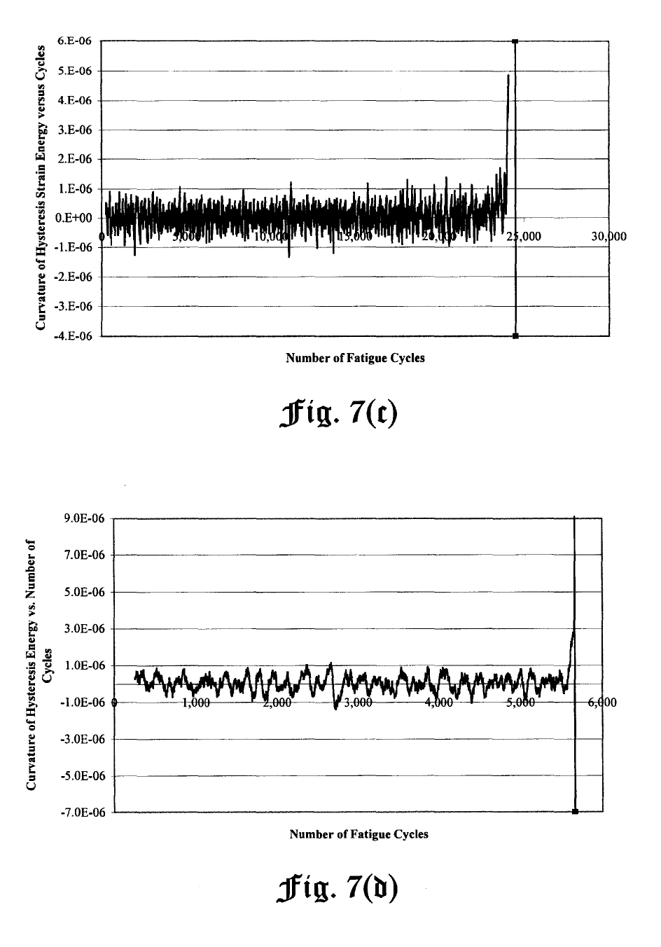

While these data do show an end-stage trend that can be used as an indication of imminent failure, a better indicator was sought. The curves were therefore subjected to the zero-phase quadratic filter, as discussed above, and the slopes and curvatures for each initial curve in FIG. 5 were derived. Slope is shown in FIG. 6, and curvature in FIG. 7. Slope, for example, indicates how quickly the energy consumption is rising.

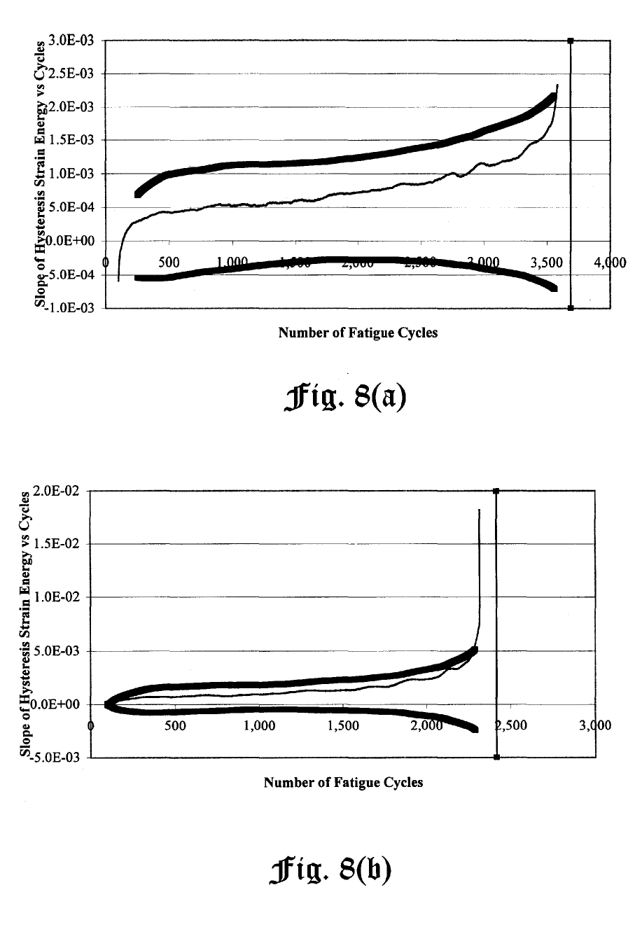

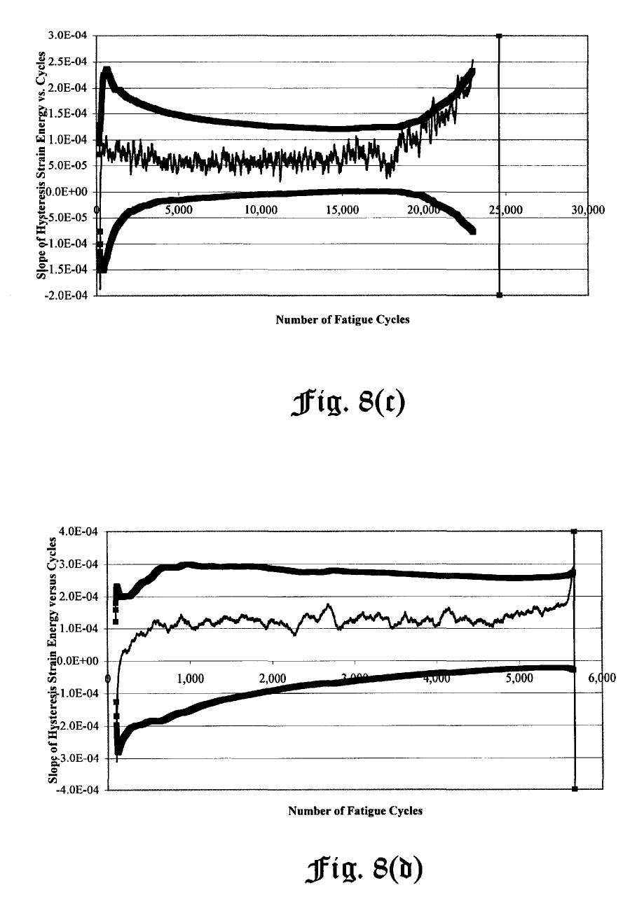

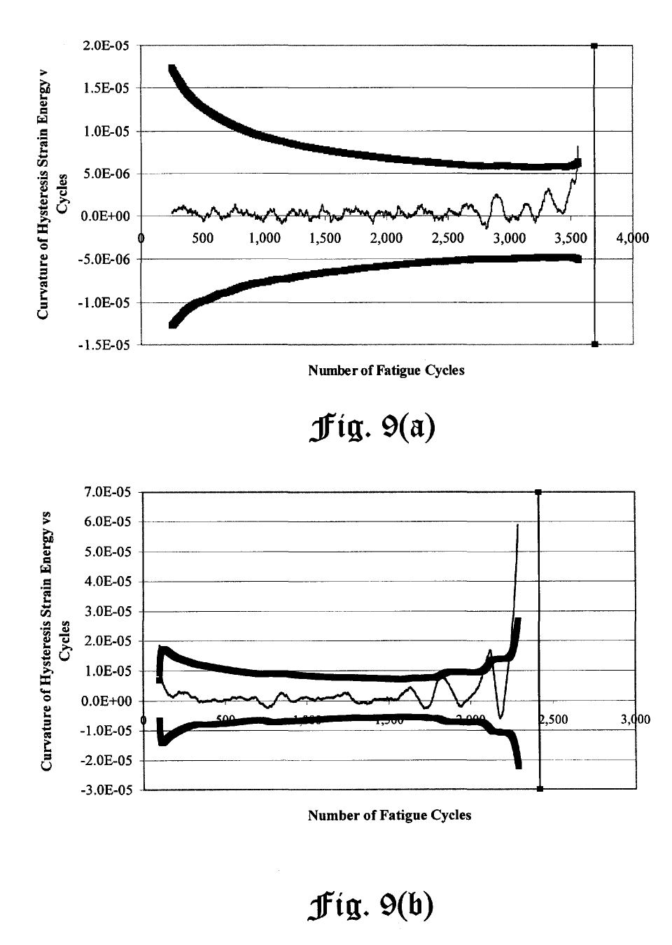

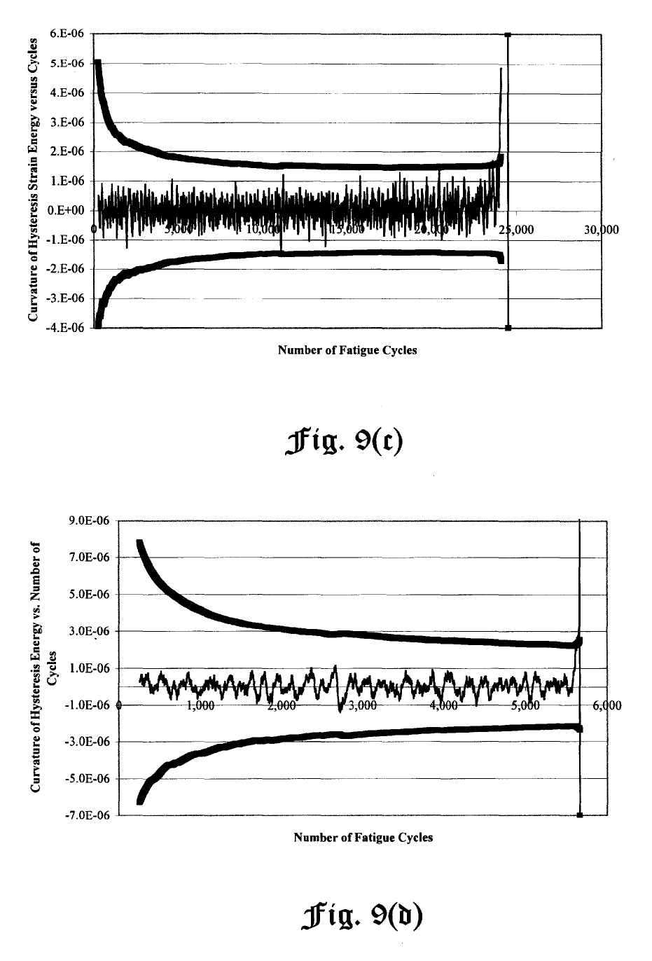

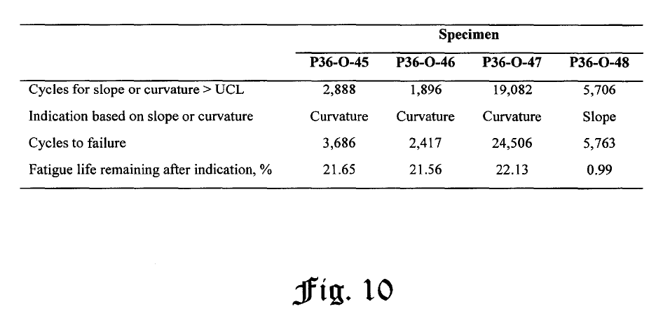

As is illustrated, the slope and curvature functions, used as indicator functions for the onset of the end-stage crack growth rate trend, provide more readily ascertainable indications of end-stage, unstable crack growth. As is set forth above, a more uniform method of detecting the desired trend involves the derivation of limit functions. The limit functions, calculated as shown, are chosen to minimize the occurrences of false positives and false negatives. FIG. 8 shows the smoothed slope of hysteresis strain energy versus the number of cycles, with upper and lower limit functions calculated point by point as the data progress. FIG. 9 shows similar graphs for the curvature of the hysteresis strain energy. These figures show that the HSE slope and HSE curvature exceed the limit functions in advance of the failure points, thus providing a reliable indication of the onset of the end-stage trend presaging failure. The predictive capabilities thereof are shown in Table 2 of FIG. 10.

### III. EXAMPLE II

Data were obtained for tensile load and tensile strain on ten aircraft aluminum coupons with expected fatigue lifetimes in the 10,000 to 100,000 cycle range. The hysteresis strain energy being consumed by the coupons was calculated, followed by zero-phase quadratic filtering, the derivation of slope and curvature, and the calculation of upper and lower control limits as discussed above.

The coupon material was unclad 2024-T3 aluminum alloy sheet, a material commonly used in aircraft skins. The coupons were obtained from the outer skin of an U.S. Air Force KC-135, having a nominal thickness of 0.090 inches. They were machined to an ASTM E466 standard fatigue specimen with reduced cross-sectional width, with a 1.3 inch long by 0.50 inch wide gage section for the 1-inch extensometer. The apparatus and procedures were as described in Example I, but data recording frequency was 400 Hz/channel/second, producing about 400 measurements of each variable over each fatigue cycle.

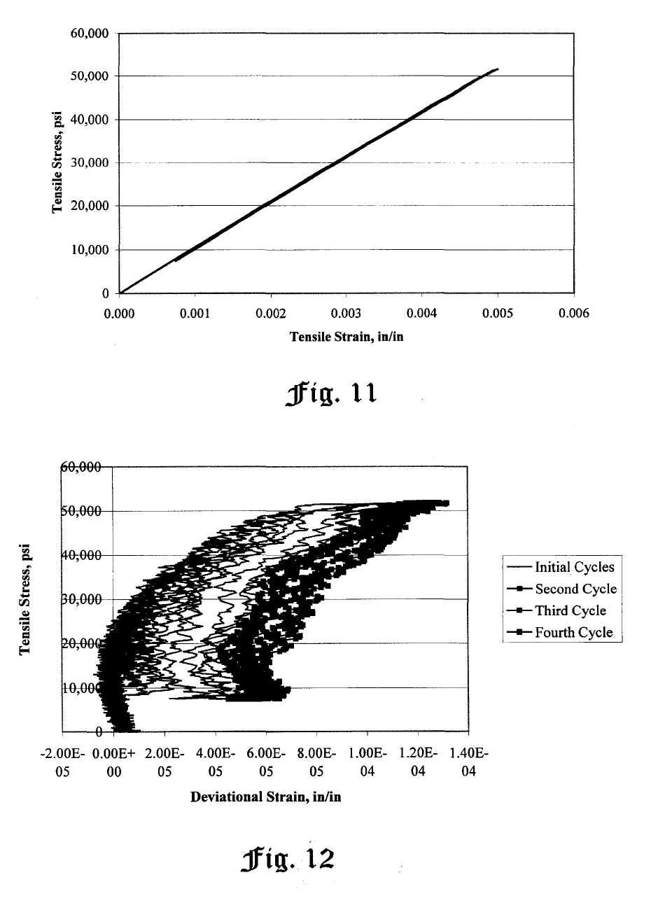

An initial stress-strain curve for a test sample of 2024-T3 aluminum is shown in FIG. 11. FIG. 12 illustrates the deviation from true linearity of the stress-strain response of this same sample on a cycle-by-cycle basis, illustrating the hysteresis strain energy phenomenon. Table 3, in FIG. 13 shows the fatigue data test results for the ten coupons in this example.

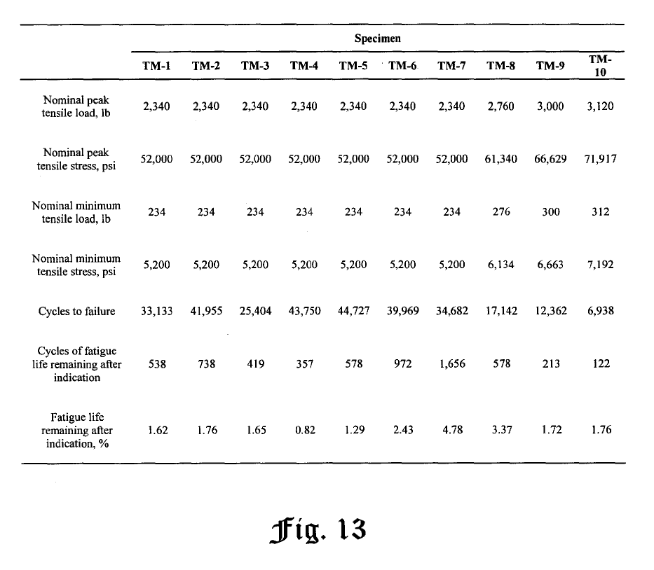

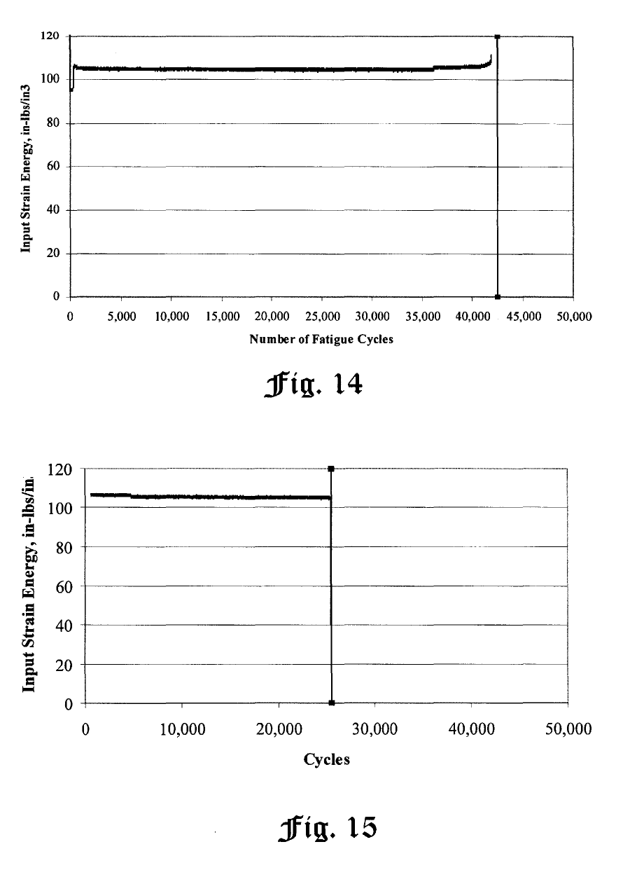

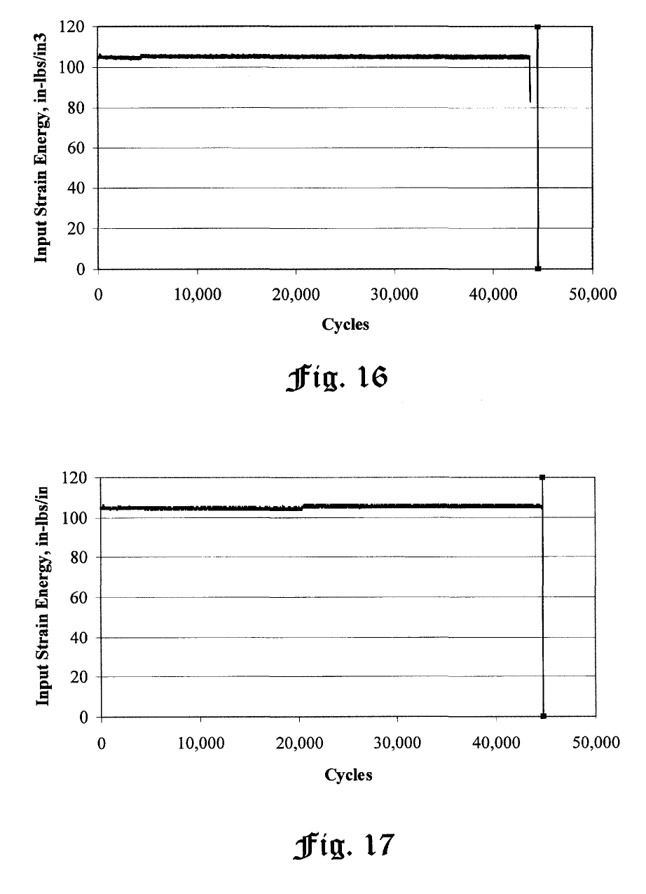

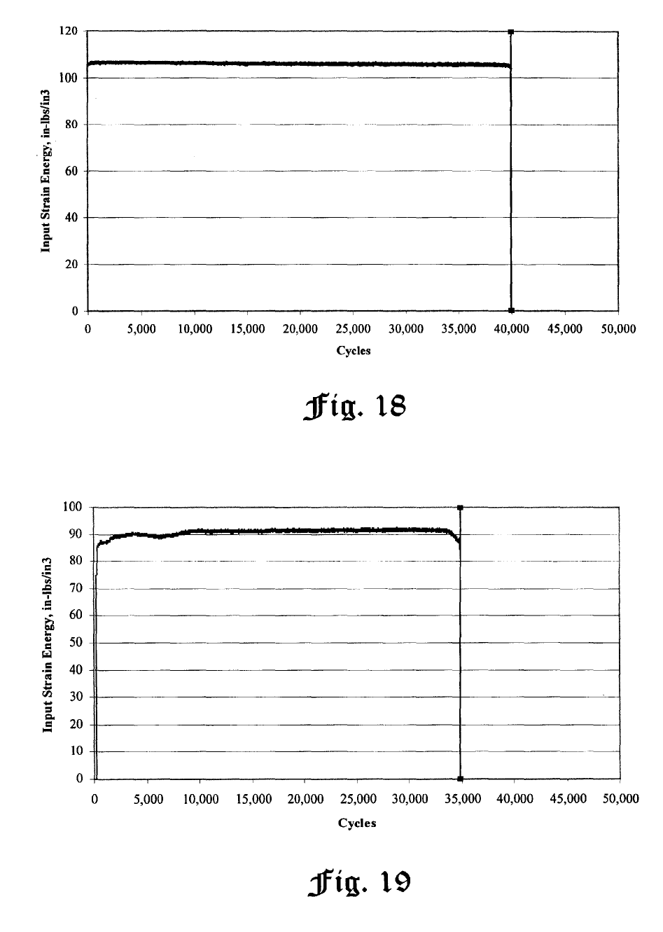

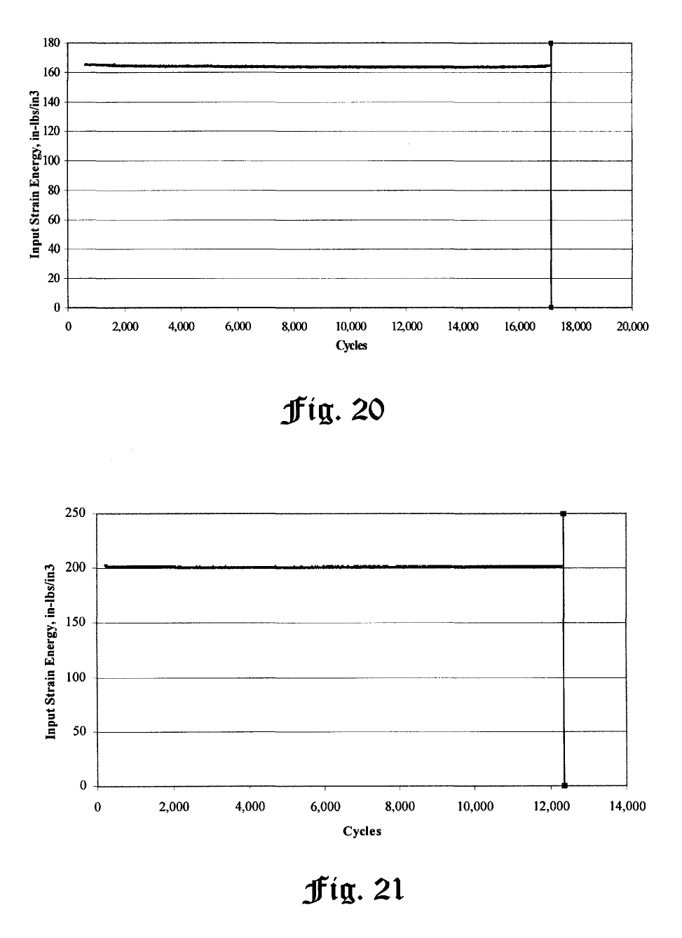

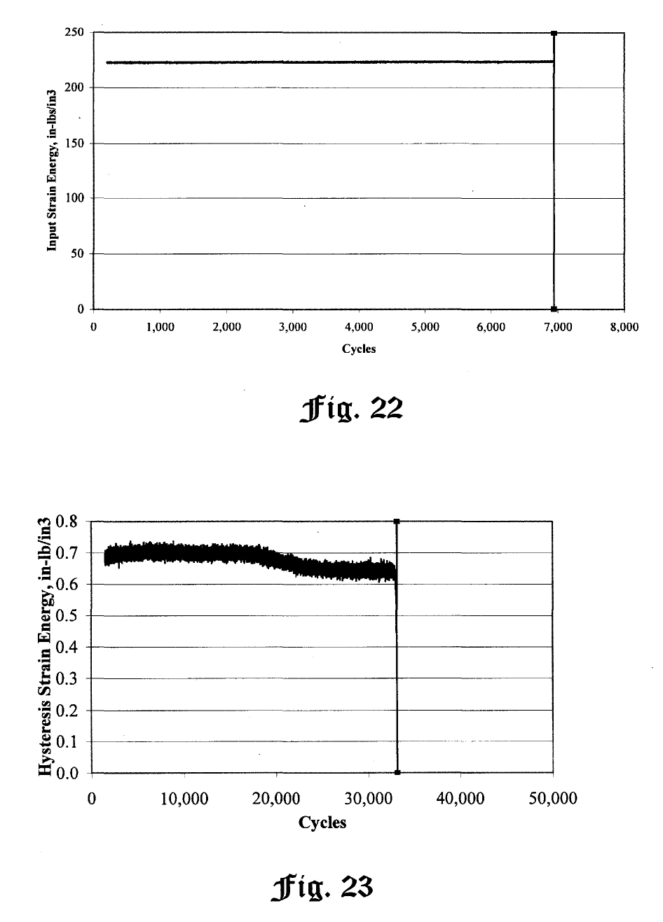

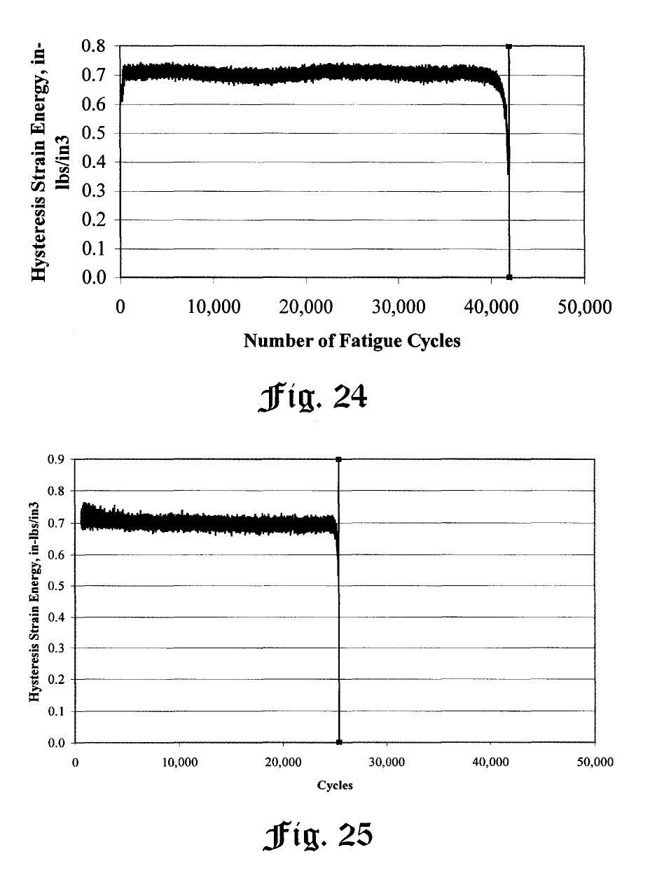

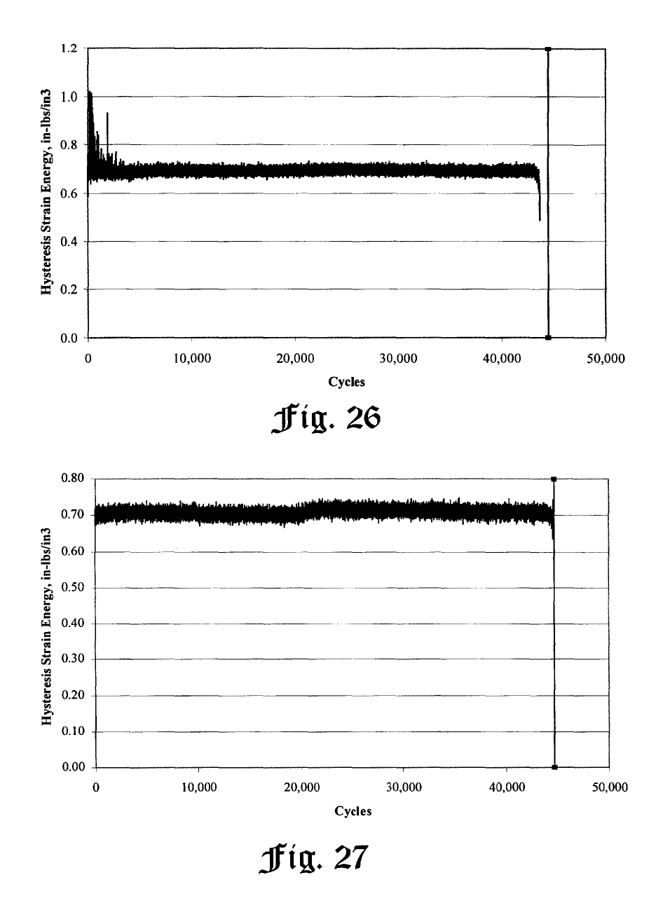

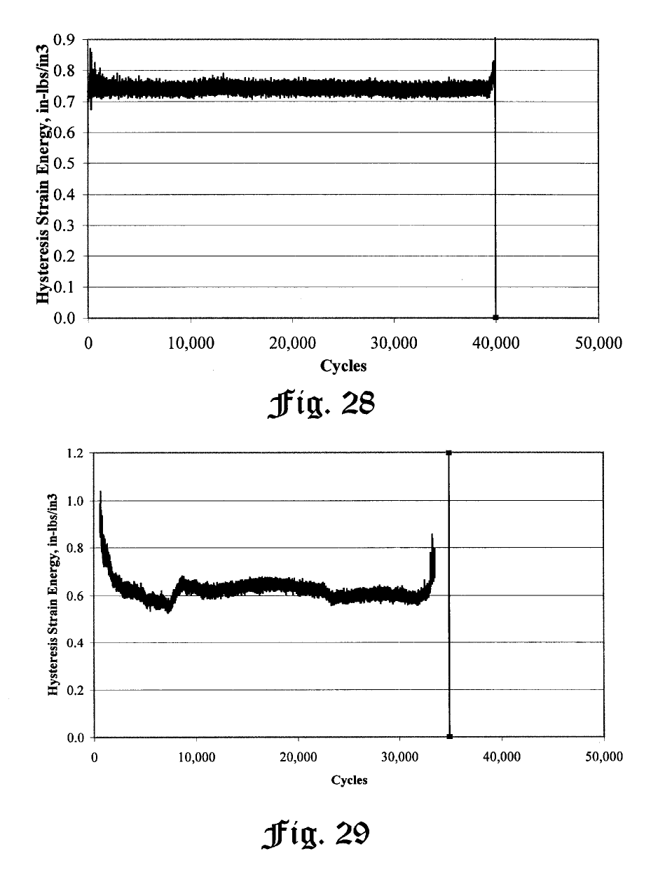

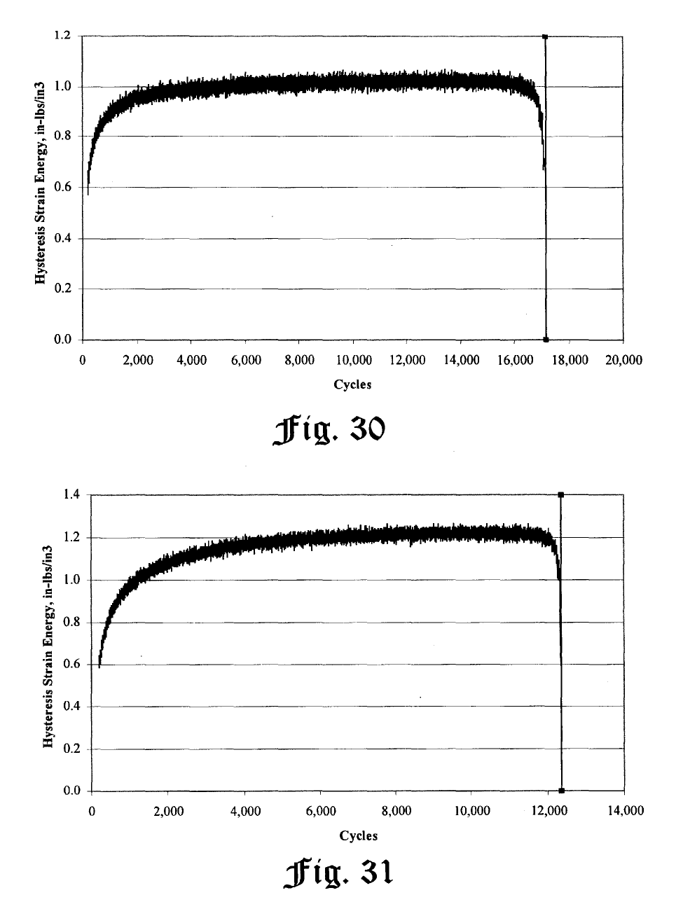

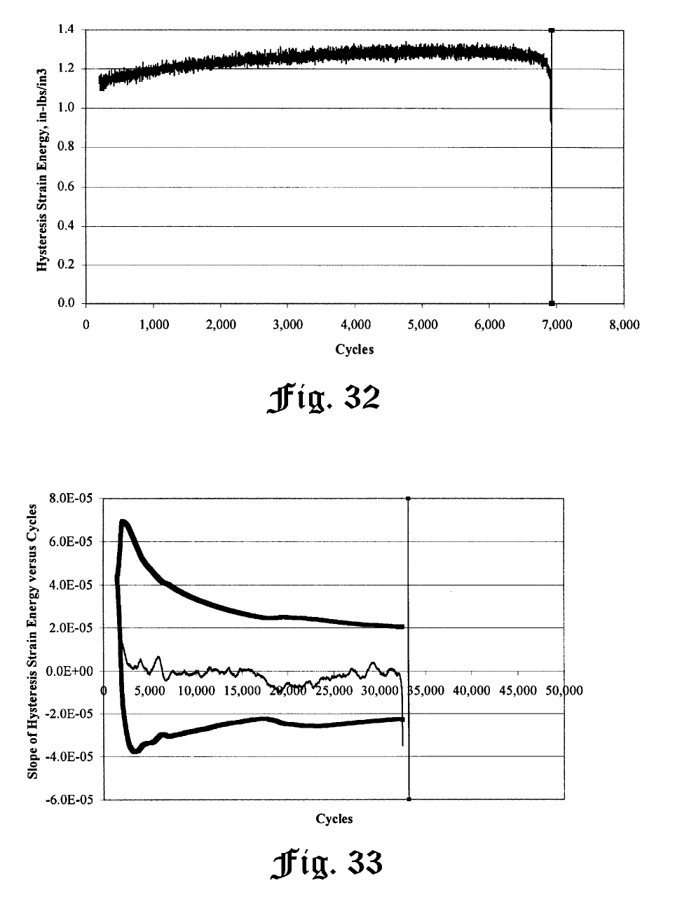

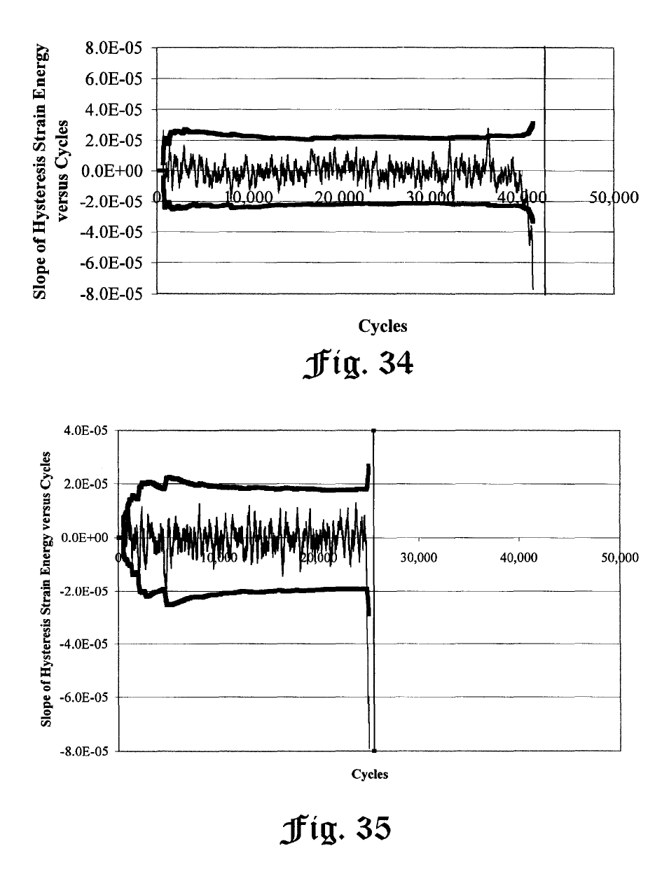

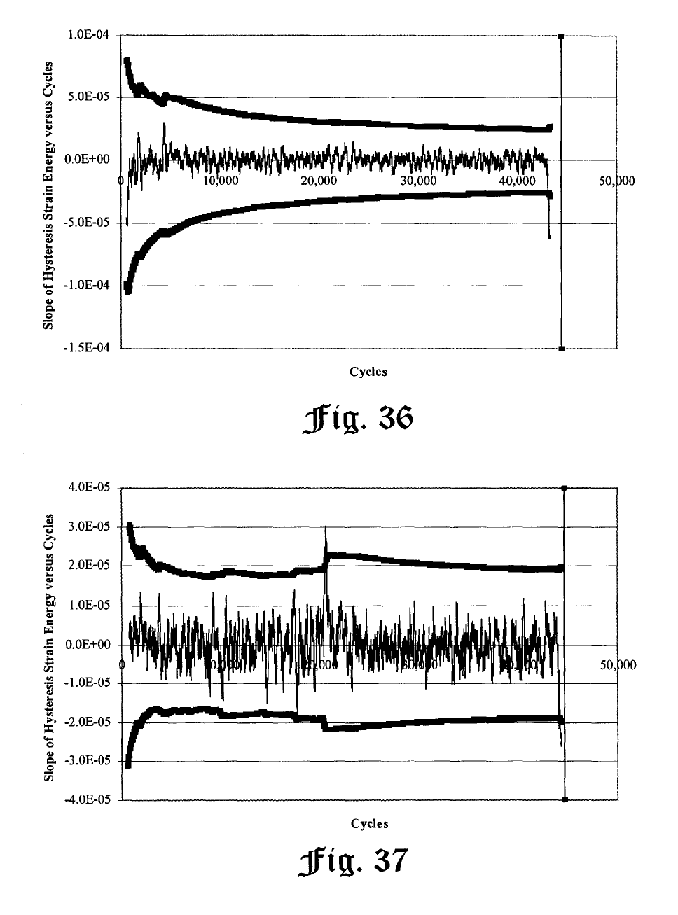

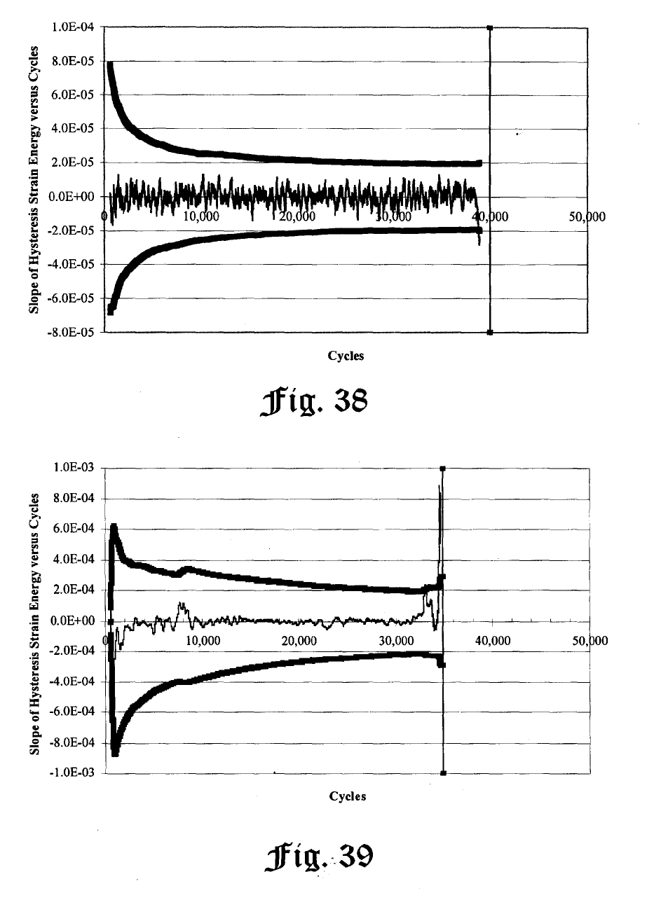

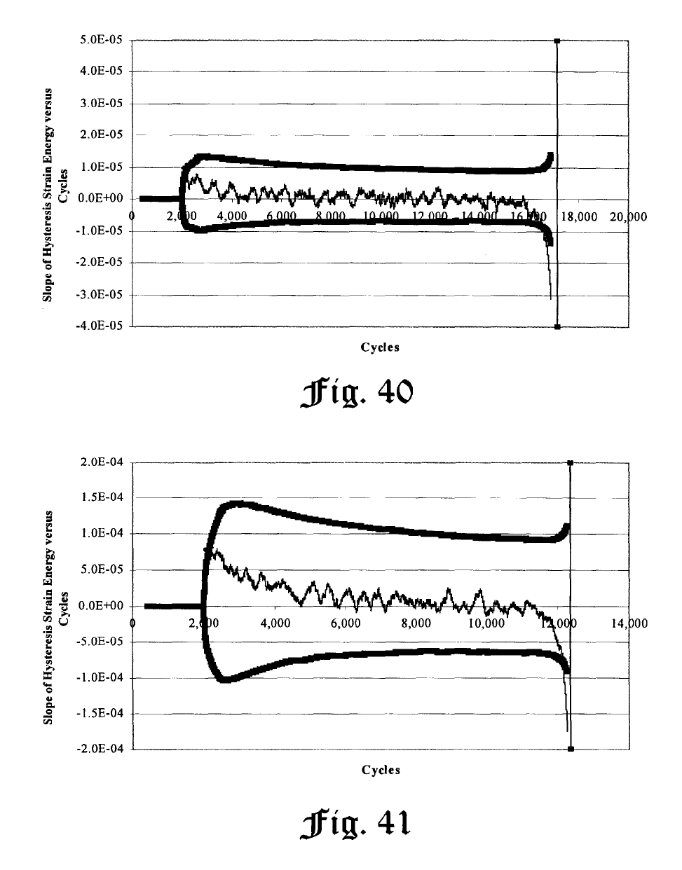

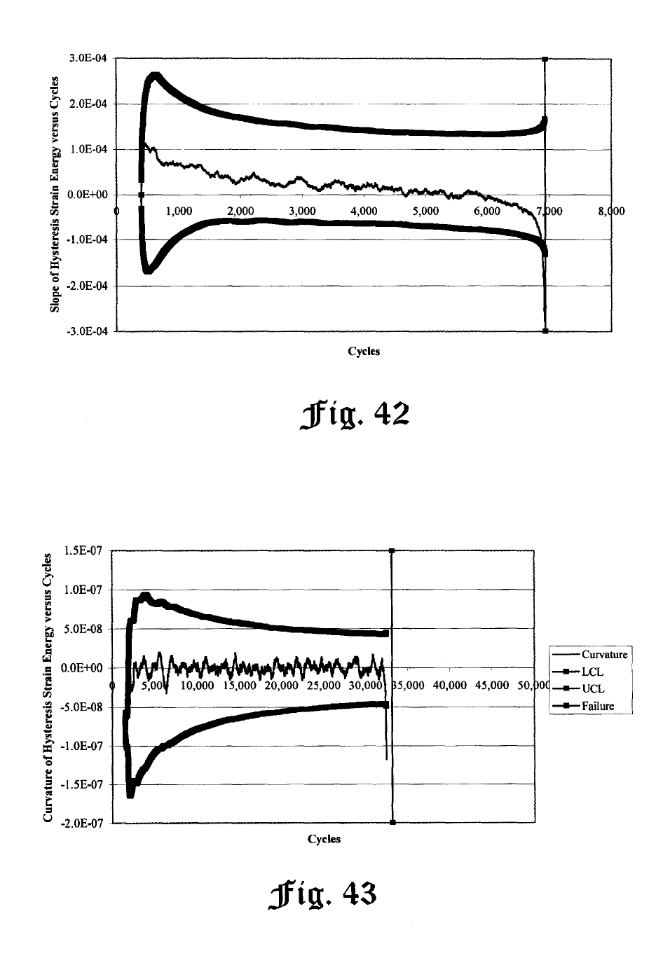

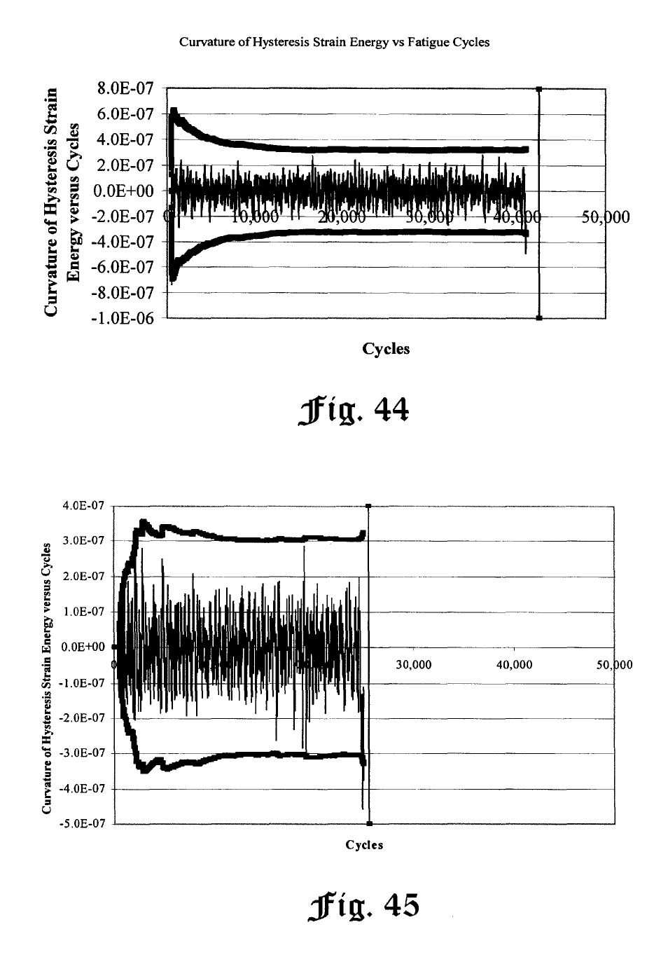

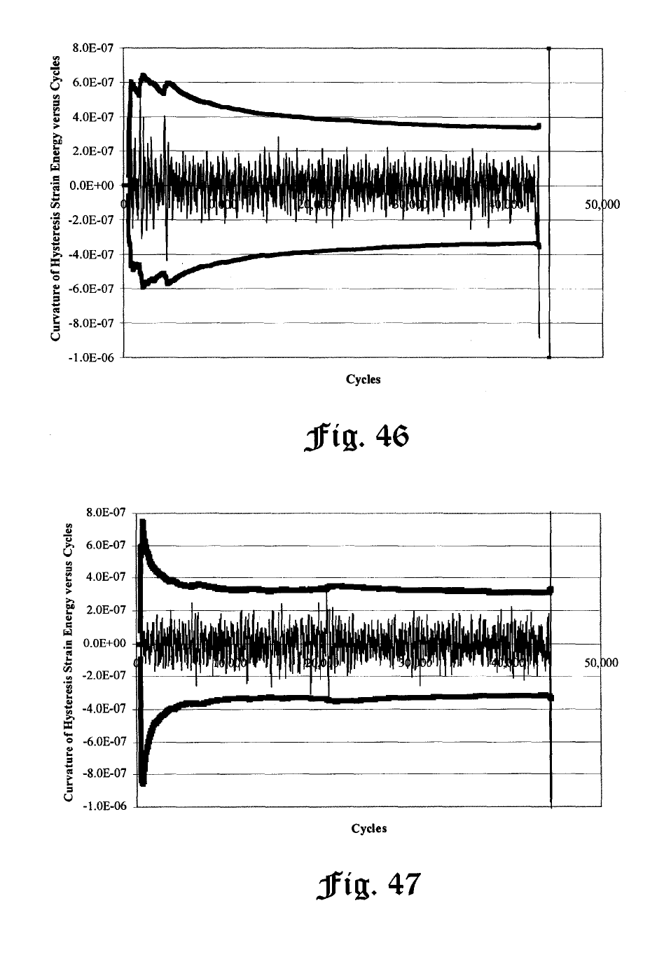

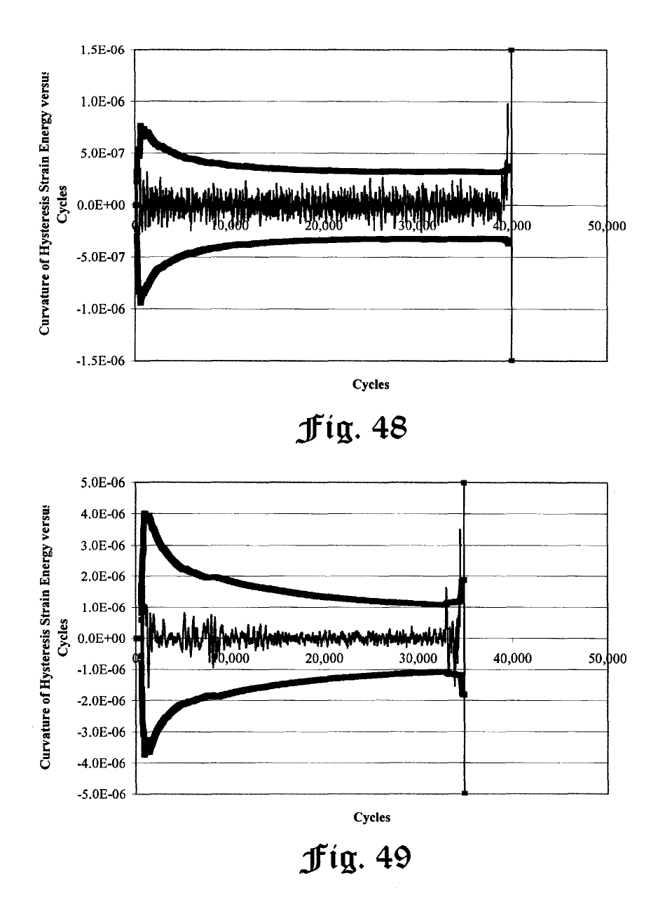

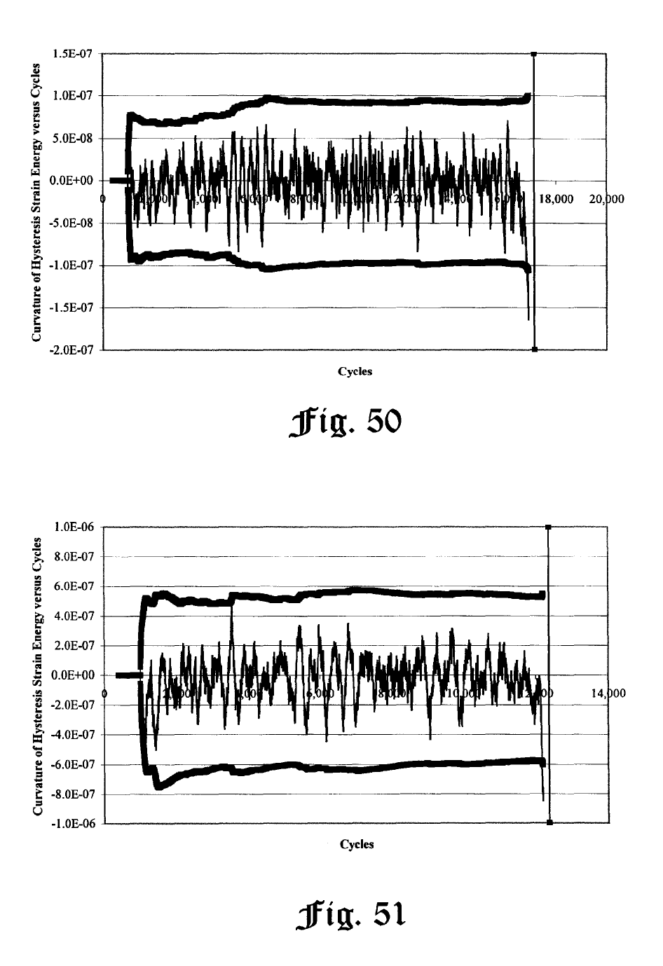

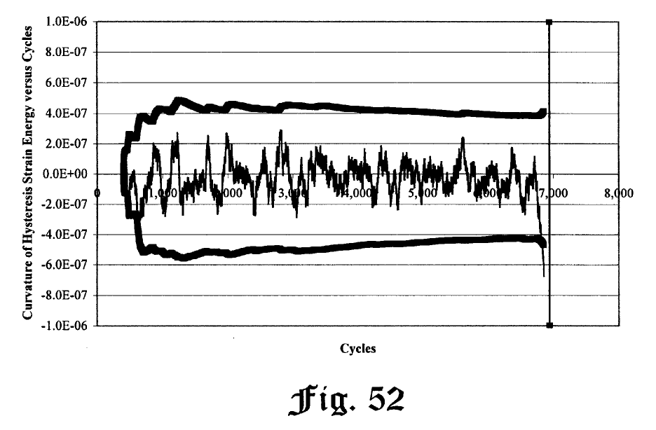

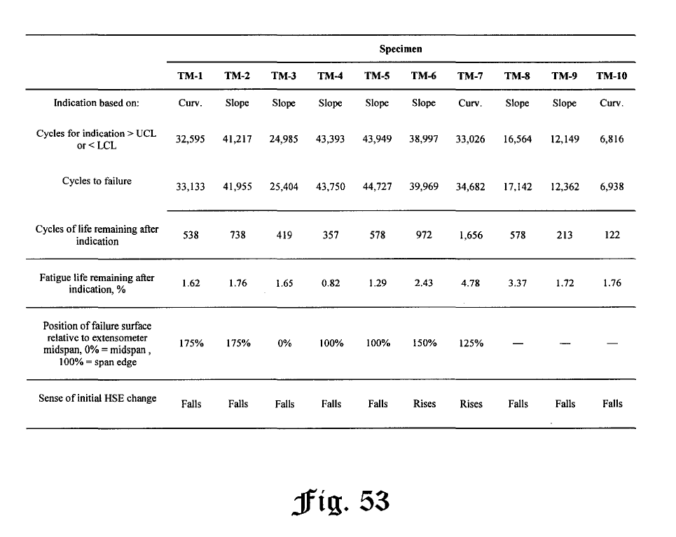

The various functions plotted from the data for the ten coupon samples are shown in FIGS. 14-52. FIGS. 14-22 show the plots for the input strain energy versus the number of cycles for samples TM-2 through TM-10 (this data was not plotted for TM-1). FIGS. 23-32 show the hysteresis strain energy plots for samples TM-1 through TM-10. FIGS. 33-42 and FIGS. 43 through 52 show, respectively, the slope functions with upper and lower control limit functions and the curvature functions with upper and lower limit functions for samples TM-1 through TM-10 respectively. As can be seen from these plots, the HSE slope or HSE curvature exceed the limit function, serving as a reliable indicator of the imminent failure of the sample. FIG. 37, for example, shows the slope function falling below the lower limit function prior to failure (the vertical line). FIG. 48 shows an example of the curvature function with the upper control limit function prior to the failure (shown as the vertical line).

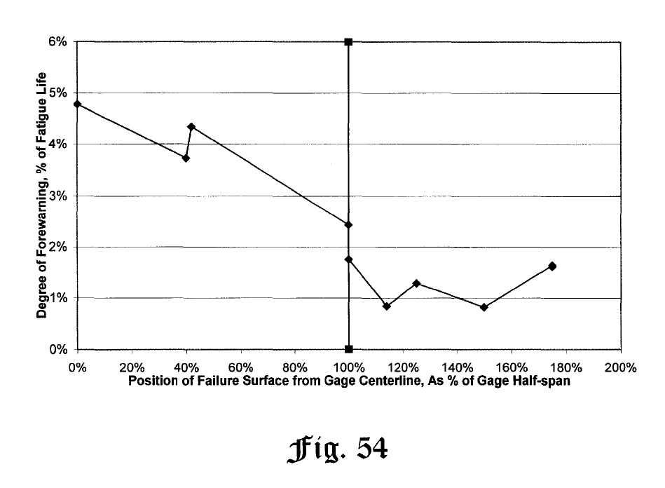

Table 4 in FIG. 53 is a numerical tabulation of the indicator function (“Indication based on:” line); the number of cycles at which either control limit function was crossed; the remaining cycles to failure; and the numerical number of cycles between the indication and the failure. Fatigue life remaining after indication is provided in percent of total fatigue life, the percentage varying from less than about 5.0% to under 1.0%. FIG. 54 is a plot of these percentages as a function of the location of the failure surface relative to the gage midspan.

### IV. EXAMPLE III

This series of tests were designed to record tensile load and tensile strain on three classes of specimens: (1) tension-tension-loaded aluminum coupons designed to simulate multiple site damage (MSD) situations by containing a single drilled hole in the center of the gage section; (2) flexure-flexure-loaded I-beam samples in a four-point bend test; and (3) tensile-loaded single lap shear loaded coupons. The method of deriving HSE, slope, curvature, and control limit functions was the same as described above.

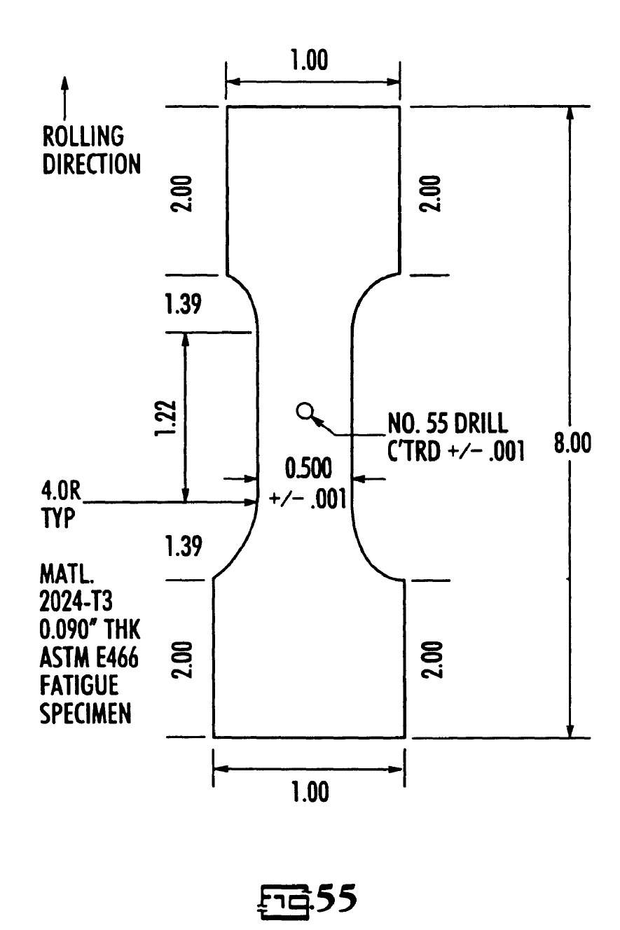

The sample material used for the tension-tension test was unclad 2024-T3 aluminum alloy with a thickness of 0.090 inches. The coupons were machined to an ASTM E466 standard fatigue specimen with cross-sectional dimensions of 1.22 inches long by 0.5 inches wide at the gage section. To simulate MSD situations, a single No. 55 hole (0.052 inches) was drilled in the center of each specimen's gage section. FIG. 55 is a sketch of a coupon specimen, showing placement of the drilled hole.

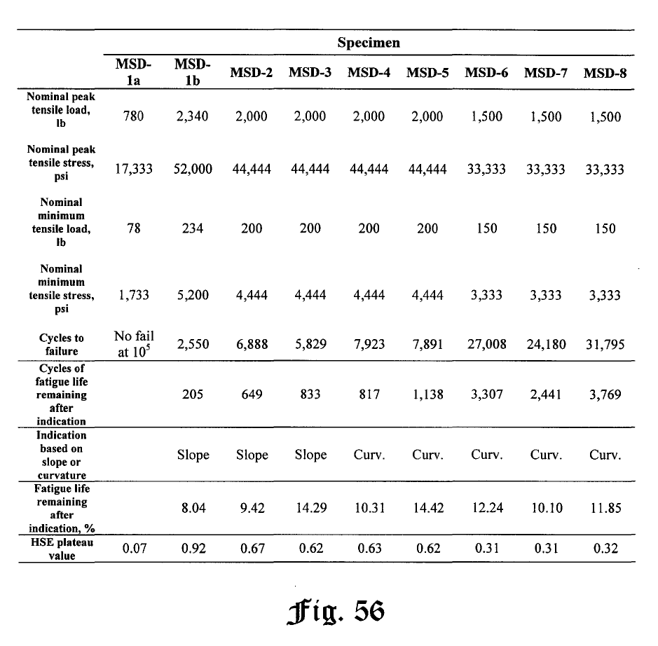

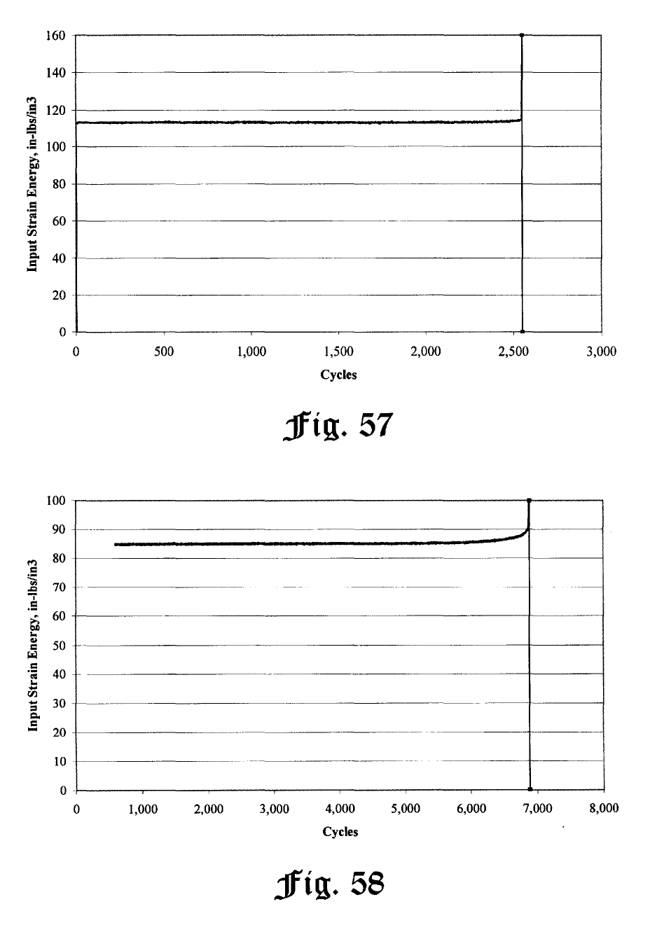

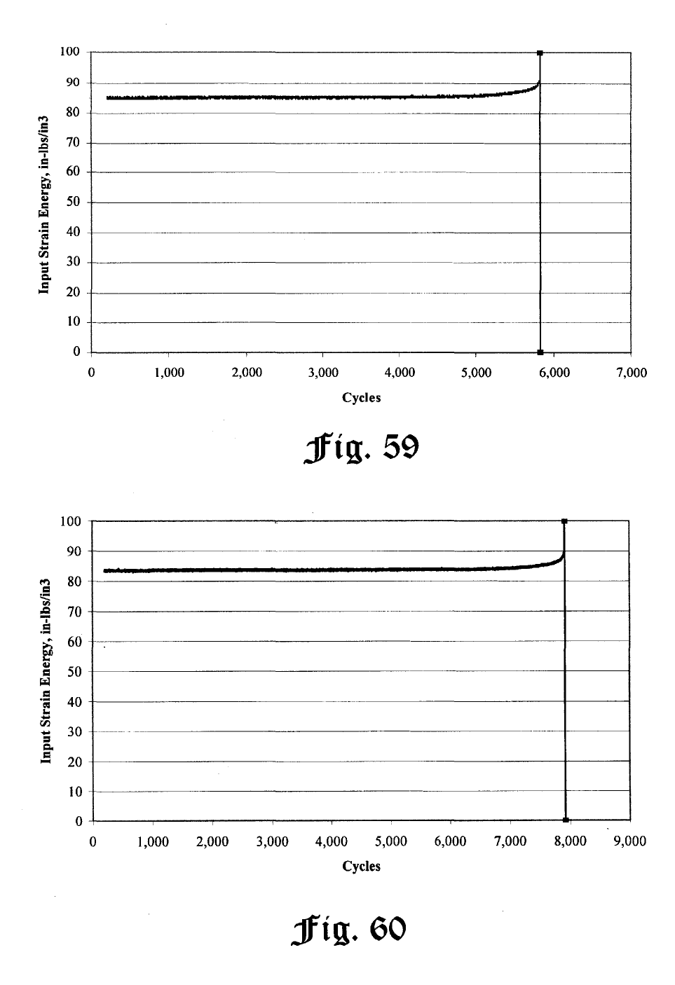

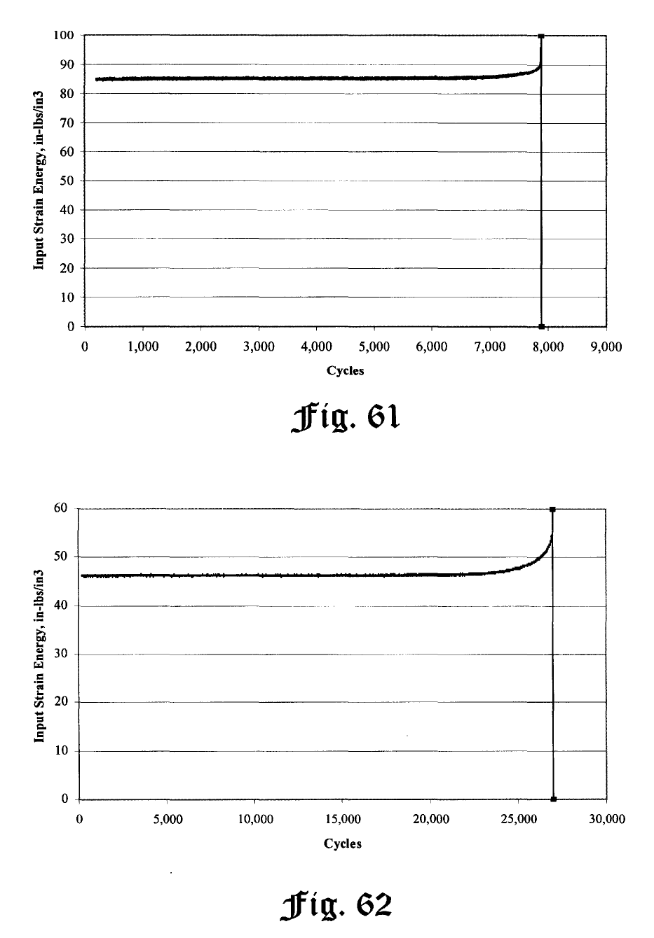

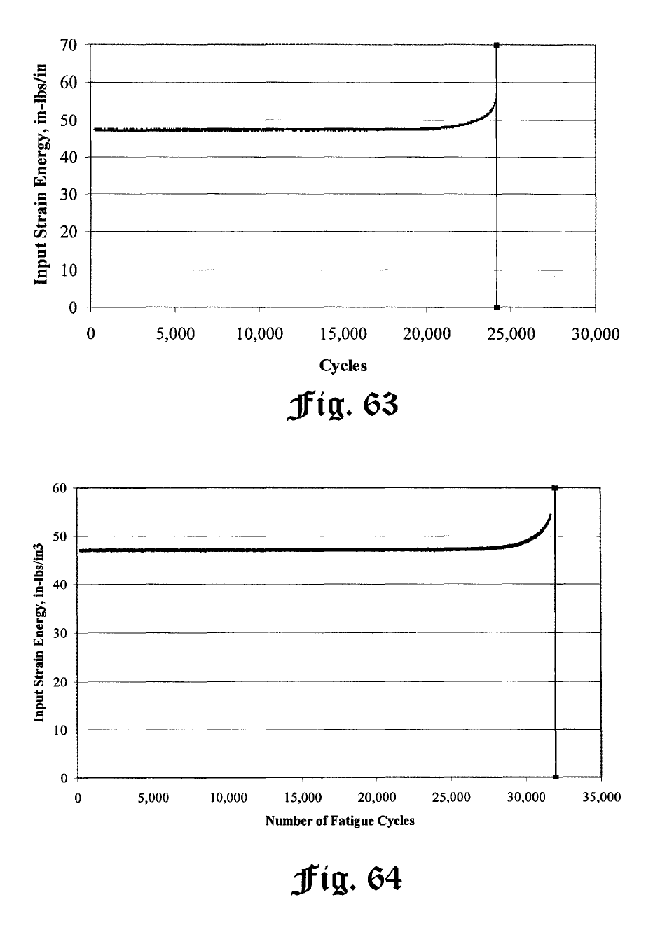

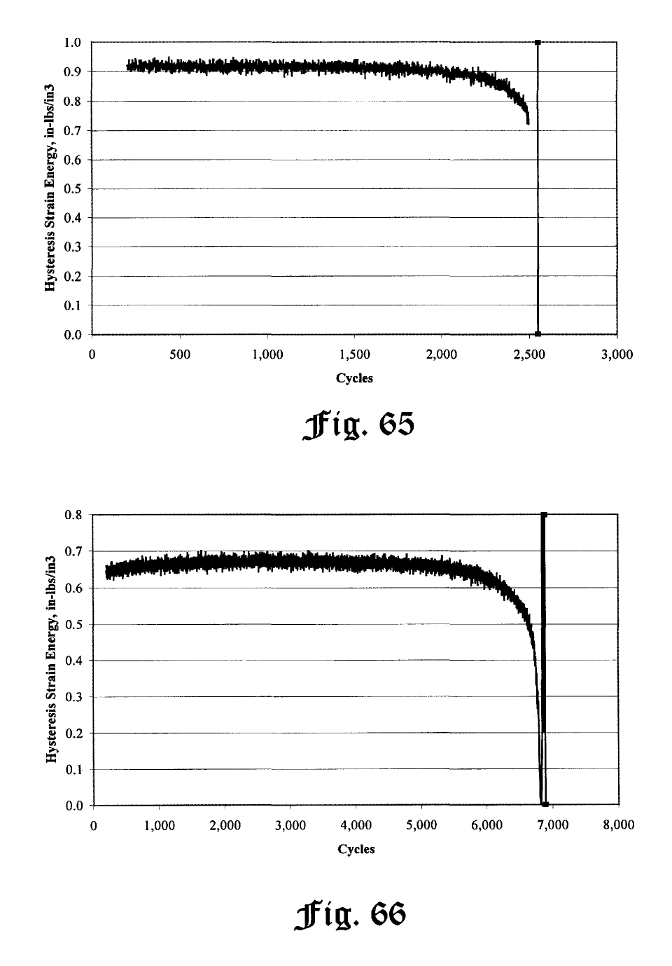

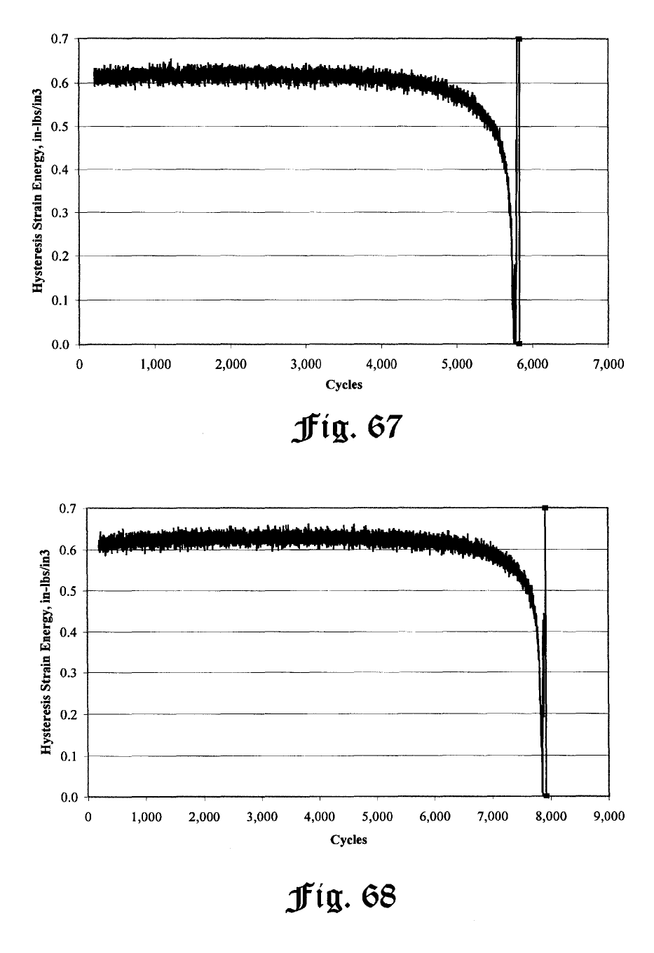

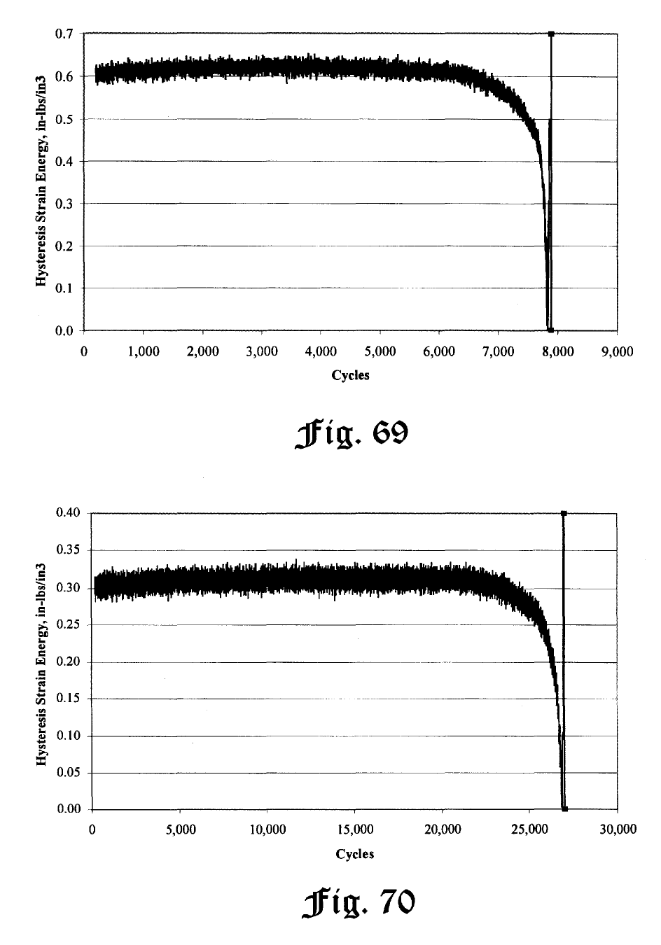

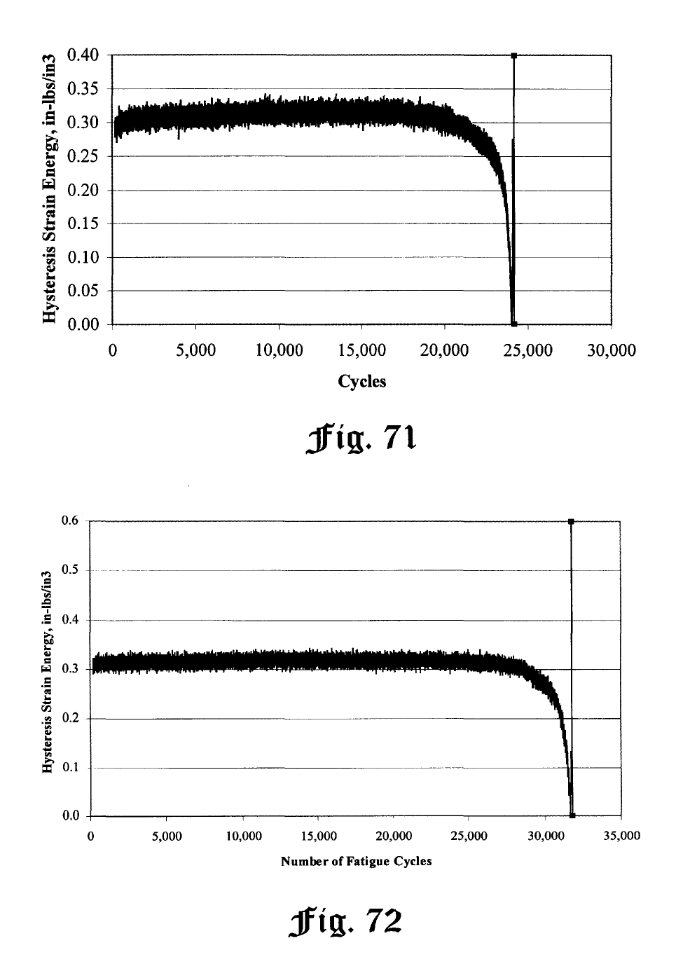

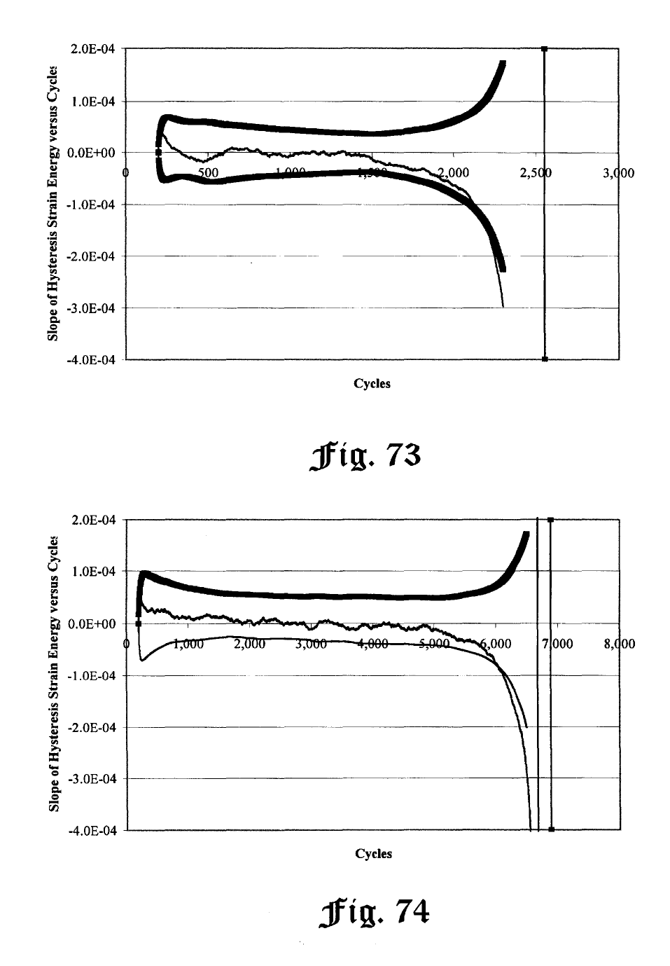

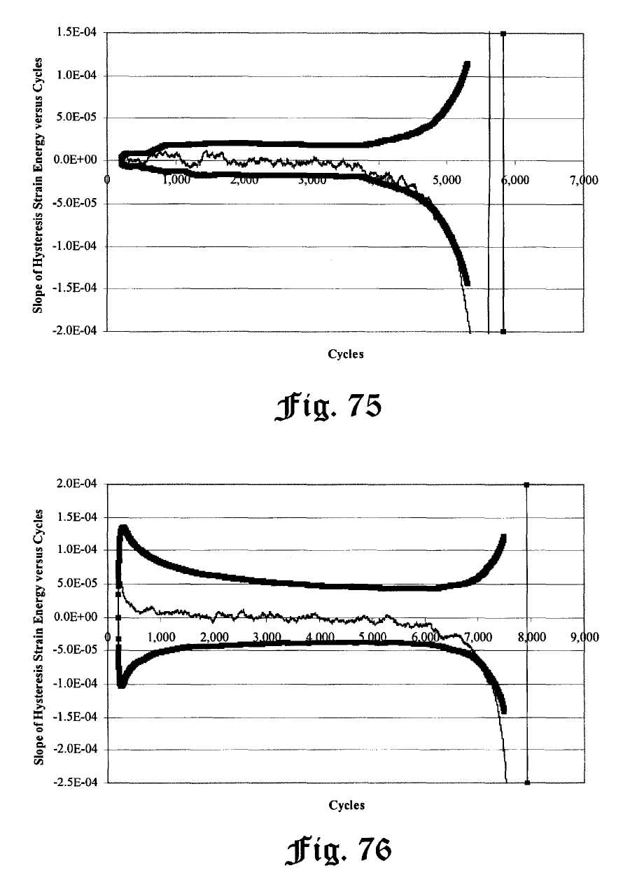

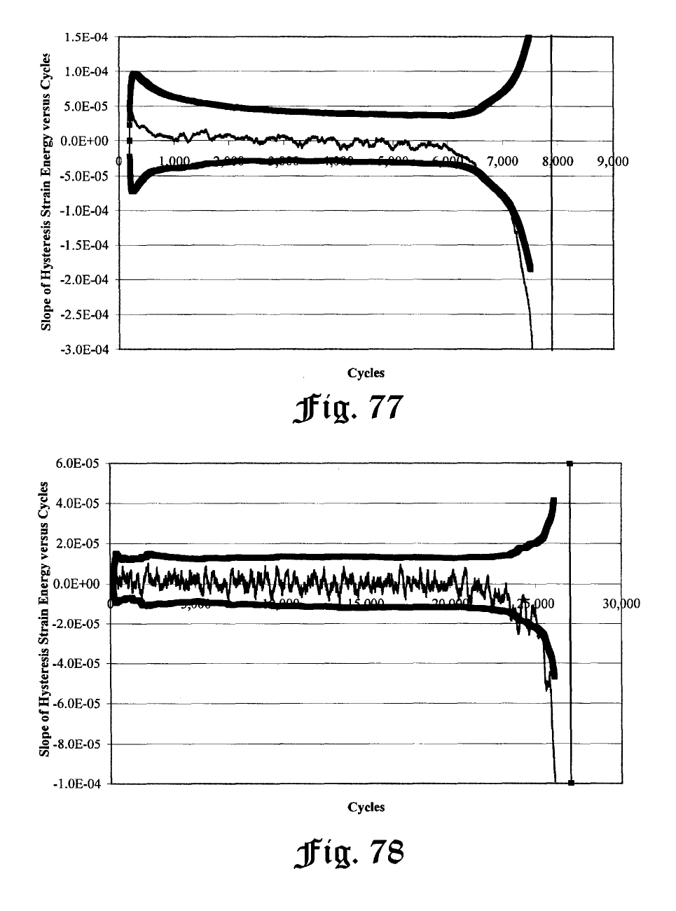

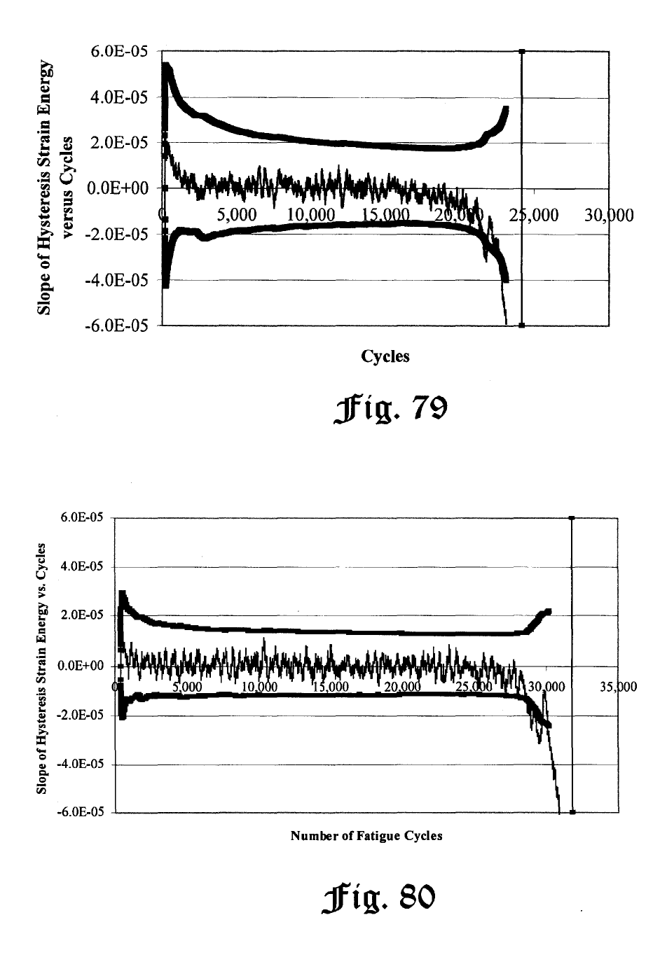

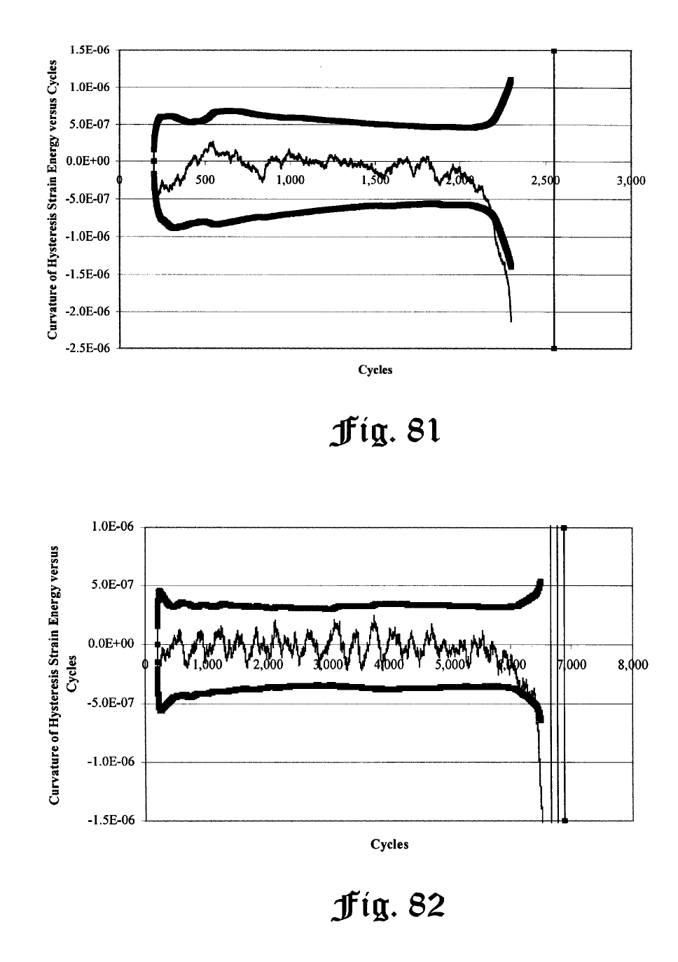

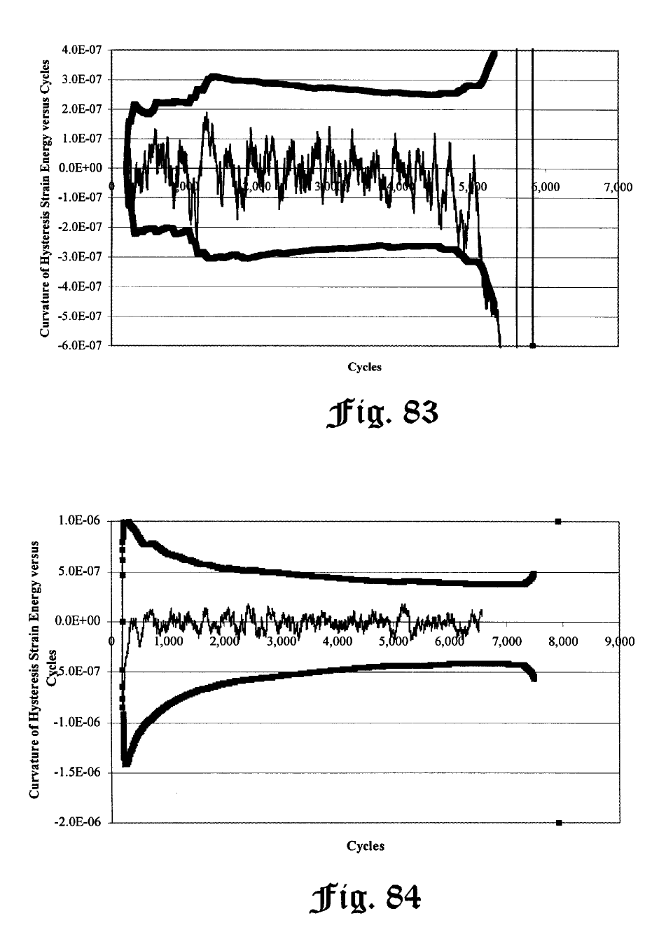

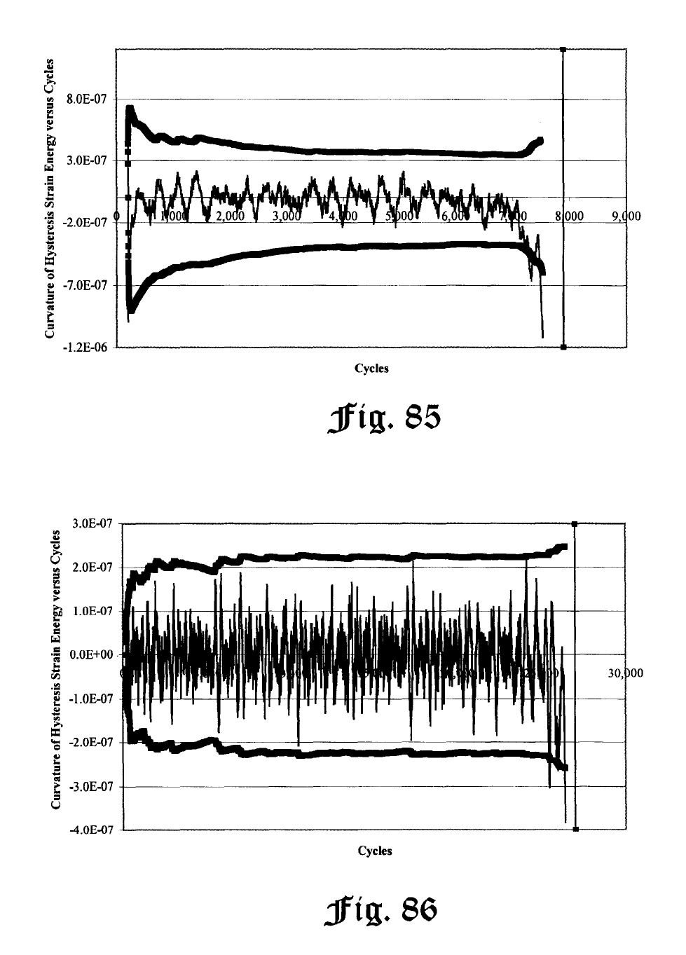

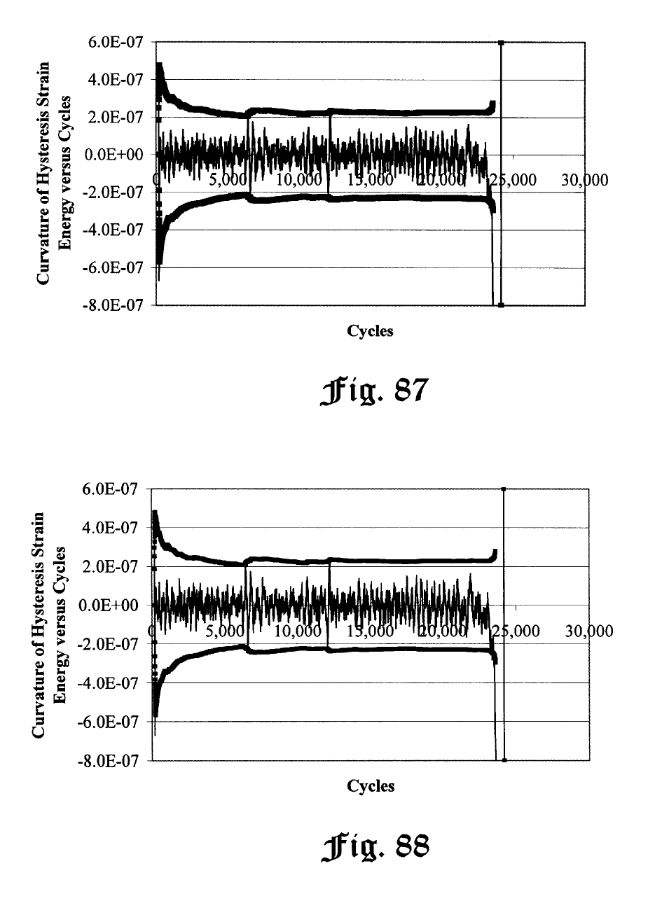

Apparatus and procedures were as described above for Examples I and II, with data collection rates of 2,000/channel/second. Eight specimens designated TM2-MSD-1 through TM2-MSD-8 were fatigue tested in tension at R=0.1. Fatigue test results are shown in Table 5 in FIG. 56. FIGS. 57-64 are plots of the input strain energy versus number of cycles for samples TM2-MDS-1 through TM2-MDS-8. FIGS. 65-72 are plots of the hysteresis strain energy versus number of cycles for samples TM2-MDS-1 through TM2-MDS-8. FIGS. 73-80—show the slope functions of the HSE functions in FIGS. 65-72 with upper and lower control limit functions. FIGS. 81-88 show the curvature functions of the HSE functions in FIGS. 65-72 with upper and lower control limit functions.

The table and the drawings show that the initial HSE consumption per fatigue cycle rises monotonically from approximately 0.07 in-lb at 17,333 psi, to about 0.3 in-lb at 33,333 psi, to 0.62 in-lb at 44,444 psi, to about 0.92 in-lb at 52,000 psi. The HSE is relatively constant until it falls sharply at failure. The HSE curves were smoothed with the zero-phase quadratic filter of the disclosure using a window of 200 cycles. Table 5 shows the predictive reliability of the intersection of the slope and/or curvature lines with the limit functions. Table 5 also shows the plateau value of the HSE, and illustrates the dependence of this value on the stress level.

### V. EXAMPLE IV

A series of tests was performed on different specimens in corroded and uncorroded states, with some specimens artificially damaged to simulate MSD. For these tests, coupons of unclad 2024-T3 aluminum alloy, with a thickness of 0.090 inches, were used. The coupons were machined to an ASTM E466 standard fatigue specimen with cross-sectional dimensions of 1.22 inches long by 0.5 inches wide in the gage section for the 1-inch extensometer used. MSD was simulated by drilling a No. 15 hole (0.180 inches) in the center of the gage section.

For each experiment, the two data variables tensile load and tensile strain in the reduced section were recorded. Loading was performed on a servo-hydraulic test machine having a 25,000 lb. tensile capacity at room temperature. Fatigue loading frequency was 0.1 Hz. Data were recorded by a National Instruments PCI 16XE-50 General Purpose I/O System of 16-bit resolution. Data recording frequency was approximately 2,000/channel/second, producing about 200 measurements of each variable over each fatigue cycle. Load cell voltage variations were on the order of about 0.1% (10 mV) of full scale (10 V), or 10 lb. Measurement resolution was 1 lb in load measurement (about 10 psi) and 5 μ∈in strain measurement.

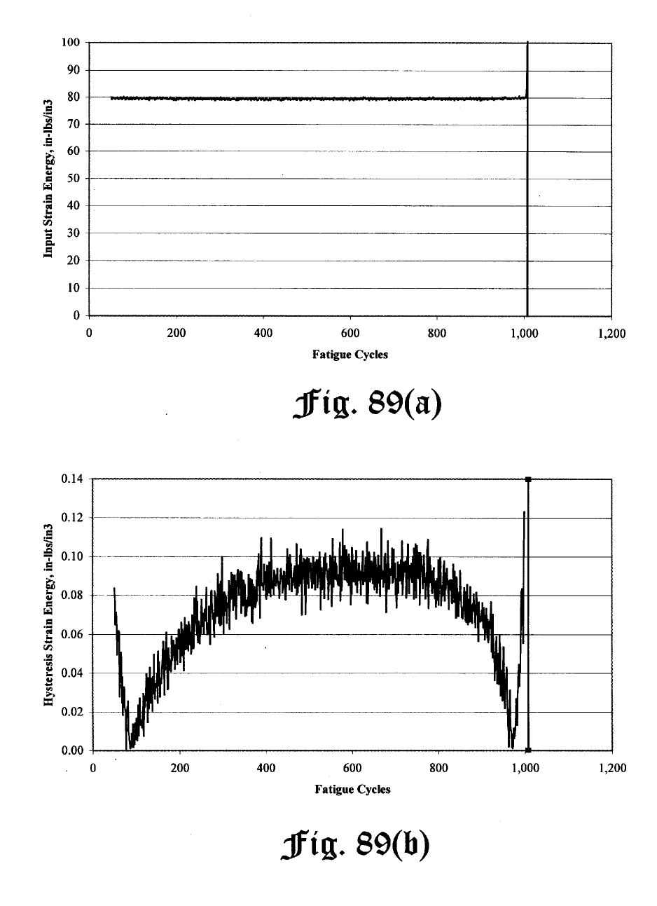

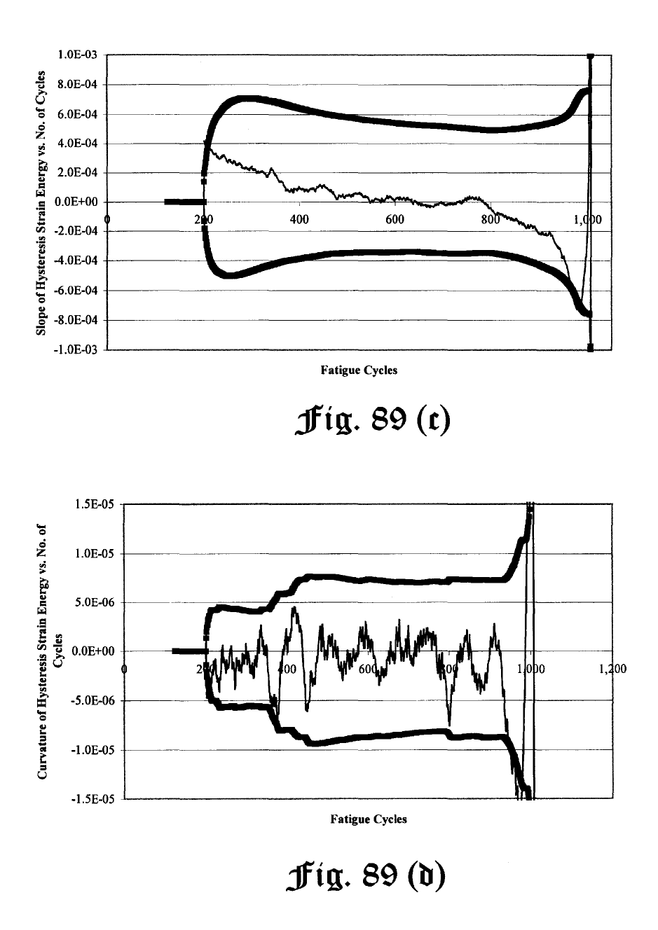

One test was conducted for an aluminum tension-tension coupon having the 0.180 inch hole to simulate MSD. The test coupon had been artificially corroded to simulate corrosion typically encountered in aircraft environmental exposure. The nominal stress test was 37,044 psi (gross section). FIGS. 89(a-d) show the data graphically for: (a) the input strain energy (ISE); (b) HSE; (c) the slope of HSE, with upper and lower control limit functions; and (d) the curvature of HSE, with upper and lower control limit functions. The observed response showed a gradual increase in HSE to a level of about 0.09 in-lb/in³, followed by a sharp drop. Even though this sample failed after only 1,008 cycles, the use of the slope and curvature functions with control limit functions provided a reliable indication of imminent failure.

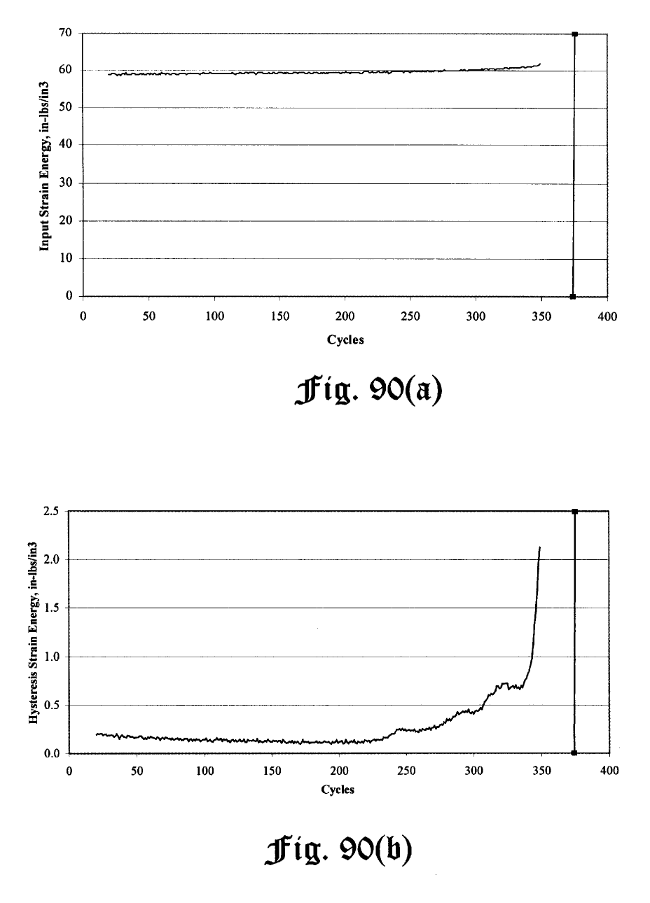

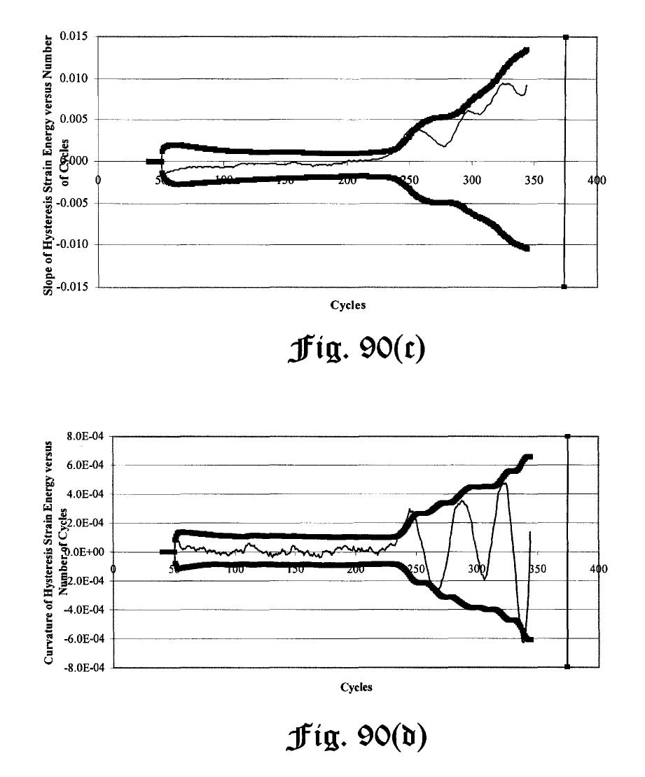

An aluminum coupon was tension-tension tested in an uncorroded state, with a 0.18 by 0.010 inch horizontal notch cut into the gage portion by electric discharge machining. Stress was constant at 38,519 psi. FIG. 90 shows: (a) the ISE curve; (b) the HSE curve; (c) the slope of HSE, with upper and lower control limit functions; and (d) the curvature of HSE, with upper and lower control limit functions for this sample. In this sample, HSE reached a plateau of about 0.2 in-lb/in³ for the early portion of fatigue life, and a rise started at about 70% of life. A sharp rise occurred during the final 10% of life. Using the convergence of the slope and/or curvature functions with a respective limit function, visible in FIG. 90(c) and 90(d), provided easy early recognition of the approach of final failure.

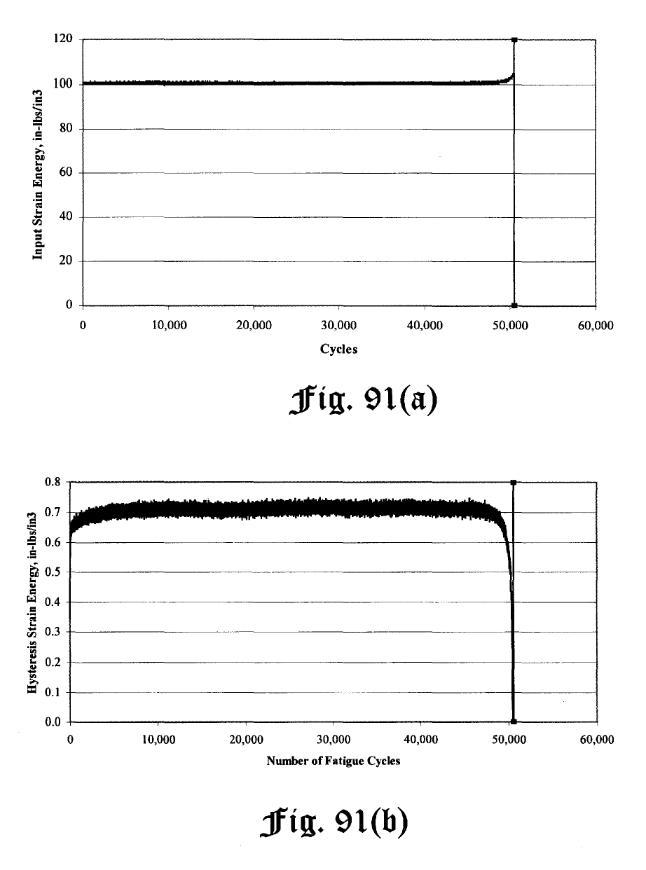

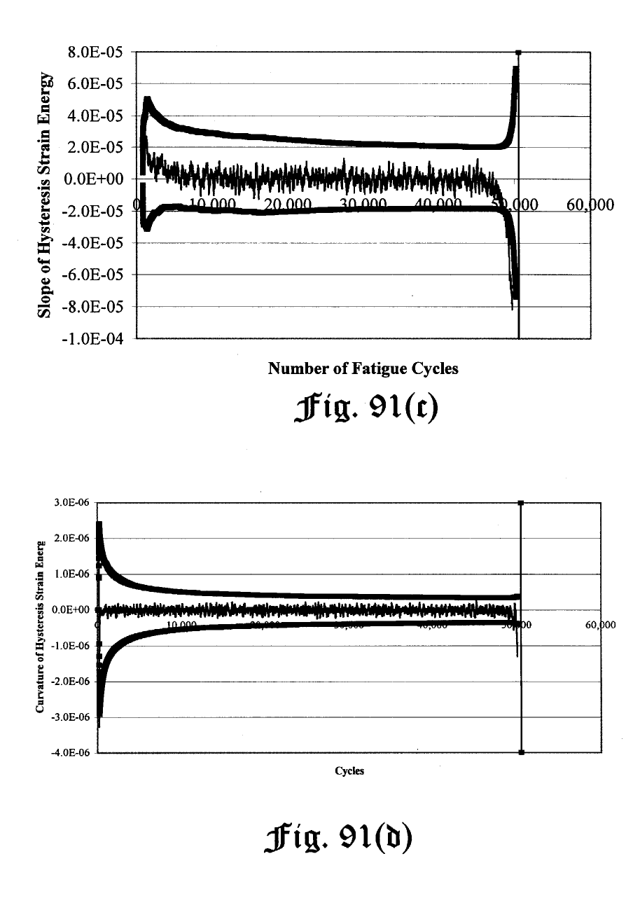

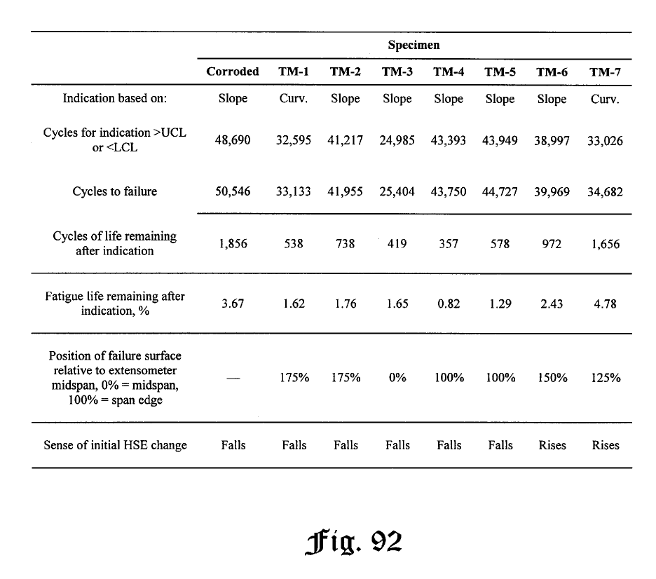

Another aluminum coupon, corroded but unnotched, was tension-tension tested at a constant stress of 52,000 psi. The ISE, HSE, slope, and curvature functions as described above are shown in FIGS. 91(a-d), and the data are compared with the data from Example II as set forth in Table 6 in FIG. 92. These data show that the method is at least as effective for providing an indication of imminent failure in corroded materials as for uncorroded materials.

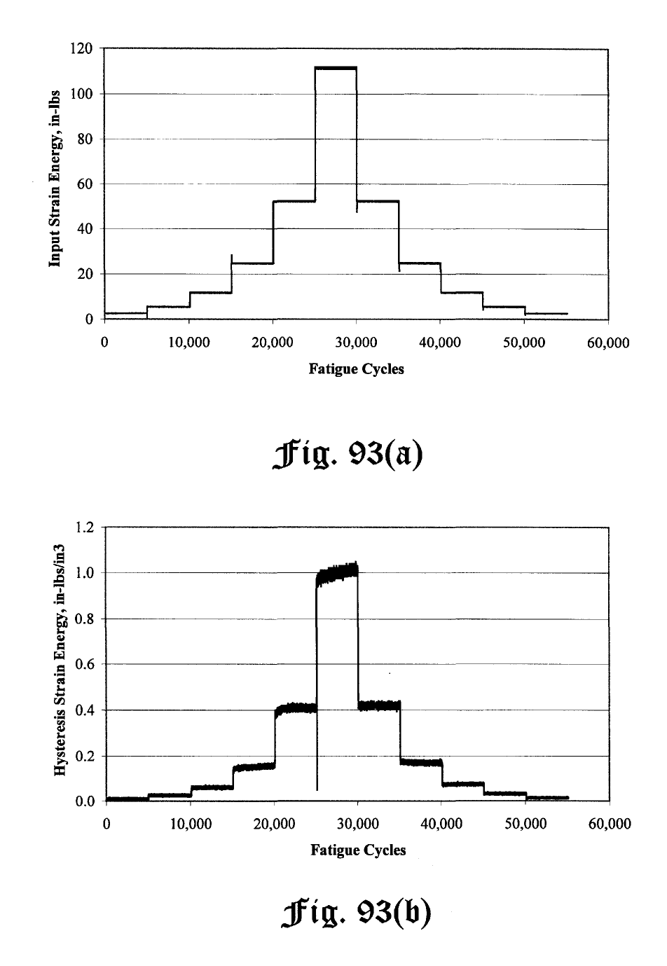

A test to record stair step fatigue amplitude was performed, using an unnotched, uncorroded aluminum coupon. The sample was subjected to a series of fatigue cycle stages of 5,000 cycles each, with the fatigue amplitude varying in equal logarithmic intervals of stress amplitude between 8,000 psi and 52,000 psi. The ISE and HSE results of this test are shown, respectively, in FIGS. 93(a) and 93(b).

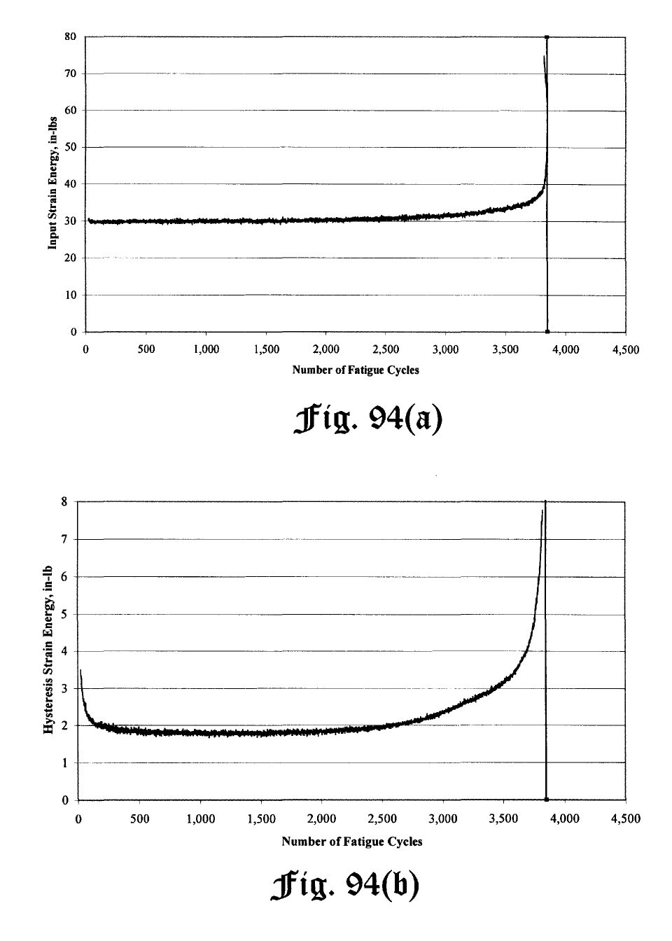

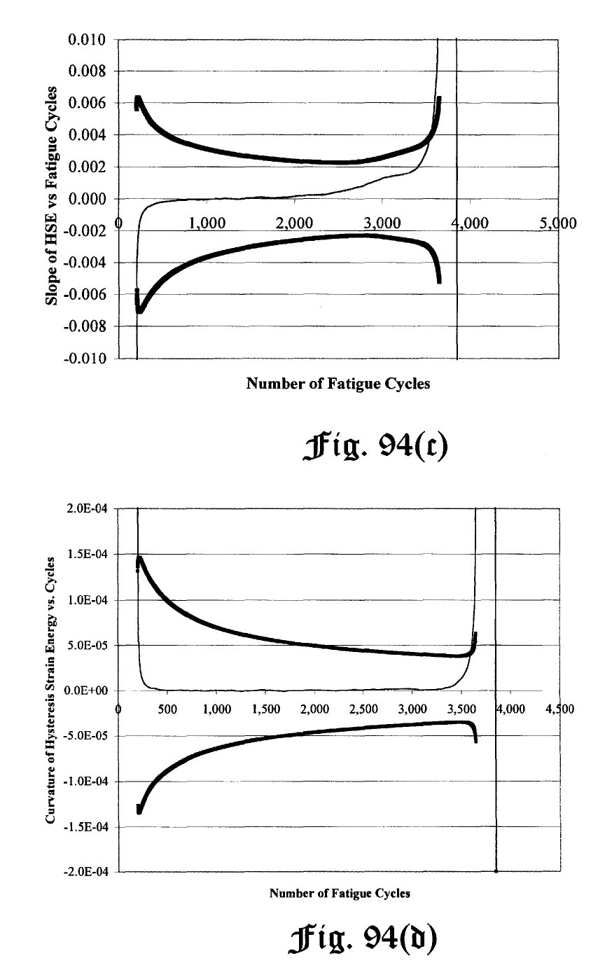

Another test was made of the method for a tension-tension Mode I crack growth test, this time using a tapered ASTM A-36 low carbon construction steel cylindrical coupon. The coupon was artificially corroded and a 0.165 inch deep circumferential notch was made. The specimen was tested with a maximum load amplitude of 42,222 lbs. and a minimum load amplitude of 4,222 lbs. at a loading frequency of about 0.1 Hz until failure at 3,850 cycles. The HSE, HSE slope, and HSE curvature are shown in FIGS. 94(a-d), as described above. This test confirmed the utility of the disclosure for use with this material.

### VI. EXAMPLE V

The series of tests in this example confirmed the utility of the disclosure in cases where stress corrosion or creep dominated as the primary cause of crack growth. The materials and apparatus used were as described above. The test coupons were unclad 2024-T3 aluminum coupons machined as described above.

To test low temperature creep, an uncorroded, notched coupon was loaded in tension to a nominal stress-intensity factor of 20.2 ksi√in (nominal stress of 36,900 psi). The notch was 0.180 inches. The coupon was held at the nominal stress load for 1.063 hours, at which point the load was increased to 38,750 psi nominal stress and held there until failure at a total time of 169.383 hours. Periodically, to test corrosion effects, a 3.5% saline solution was dropped into the notched area. The data readings were static load and extensometer displacement, measured versus time. Initial input energy was calculated, and the changes to this integral over time were calculated as a function of time under load.

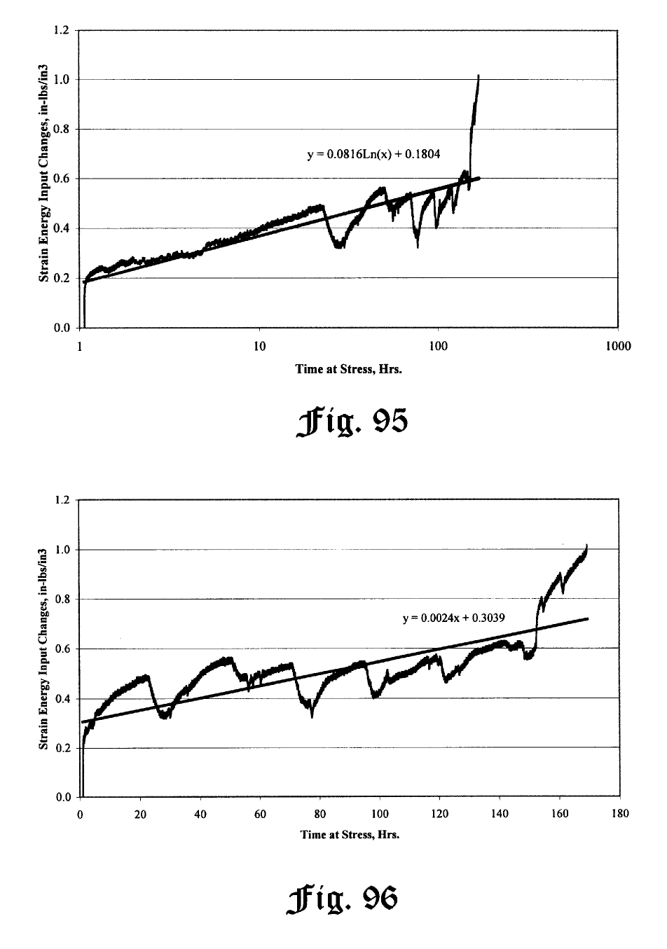

This test effectively tested both creep processes and stress-corrosion processes. Changes to stored strain energy versus time under load, referred to herein as HSE for convenience (as noted above), and the slope of this HSE are shown in FIGS. 95 and 96. The plot in FIG. 95 is scaled to show logarithmic time, thus emphasizing the initial linear rate of change of energy versus logarithmic time characteristic of creep processes. FIG. 96 is plotted against linear time, showing the characteristics of stress-corrosion rate processes. The energy changes are cyclic in nature as a result of the periodic addition of the 3.5% saline solution as a corrosion simulator. Each peak and valley represents the interval represented by the addition of a new drop of solution in the crack tip, followed by the dissipation of the solution, followed by a new drop. The final rise in value is a reliable indicator of imminent failure due to stress corrosion, failure occurring immediately after these indicators.

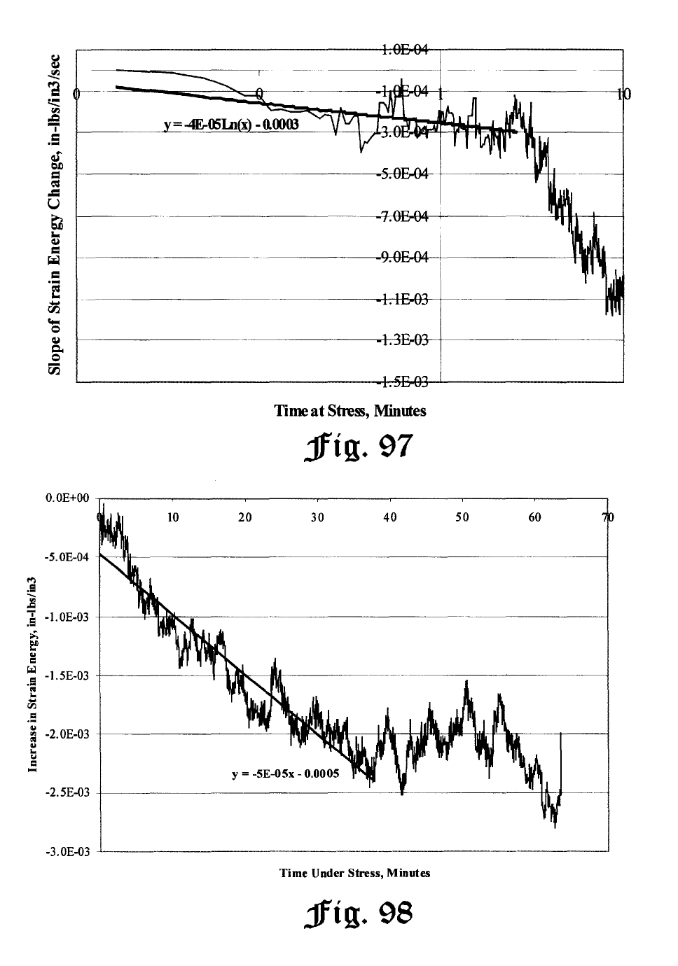

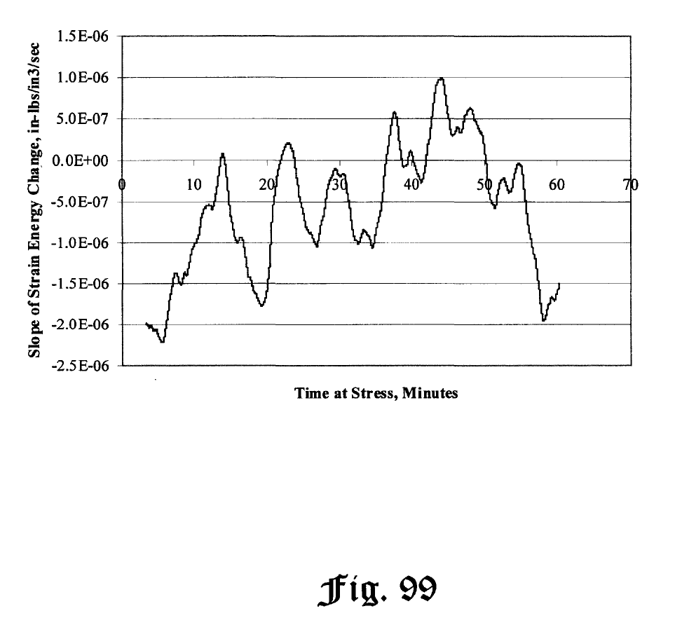

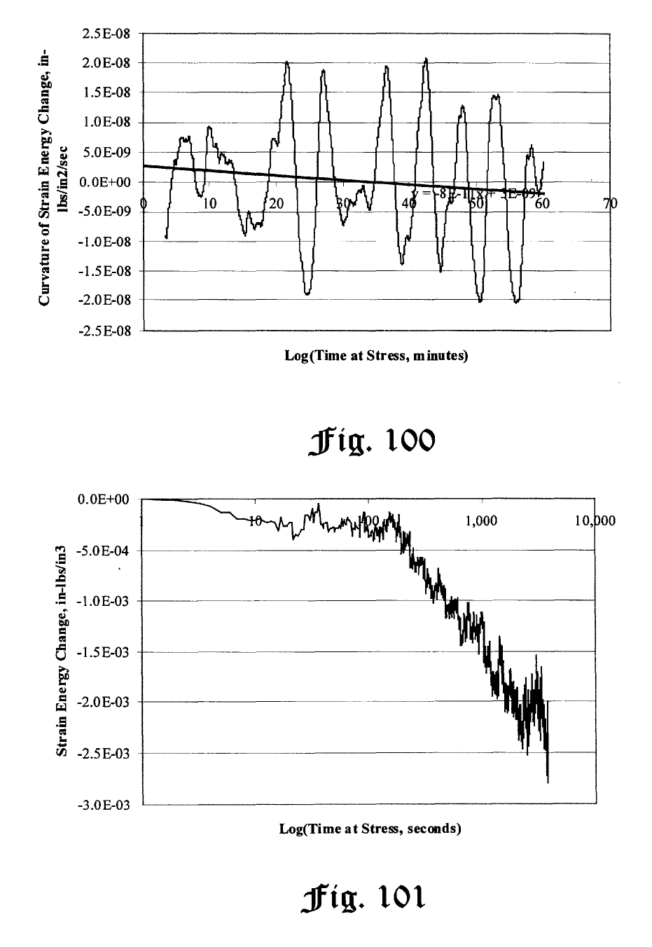

A similar test was conducted using a corroded, notched aluminum coupon with periodic addition of the saline solution. This specimen was held at a constant nominal stress of 42,000 psi, with failure occurring after 63.45 minutes. The results are plotted in FIGS. 97-101. FIG. 97 shows HSE (strain energy input change) as a function of logarithmic time, emphasizing creep characteristics. The curve initially, for about the first 100 seconds, follows that expected for creep processes, after which another process begins to dominate, the latter characteristic of stress corrosion. The peaks and valleys caused by the corrosive effect of the periodic addition of saline are noticeable. FIG. 98 plots the curve of HSE against linear time as a measure of stress corrosion. FIG. 99 is the plot of slope using linear time, the peaks and valleys being very visible. The sharp drop that signals impending end of life is clear in this plot. FIG. 100 is the plot of the curvature of the HSE curve. FIG. 101 shows the entirety of the HSE curve plotted against logarithmic time, again demonstrating the sharp drop near the end of life.

The test results from the examples confirm the utility of the disclosure for use with the four main conditions affecting crack growth. Different steps for detecting the indicative end-stage trend in crack growth rate are set forth, and a wide variety of sensors are available for providing real-time data. The associated processors can be separate or integrated, and may consist of specially designed, dedicated circuits of preprogrammed general purpose processors. The output signal may activate a physical signal such as an audio alarm, or consist of graphic representations. There are thus numerous adaptations and variations that can be made without departing from the spirit and scope of the disclosure, which are set forth in the following claims.

### VII. DETECTION OF IMMINENT STRUCTURAL FAILURE IN COMPLEX STRUCTURES

In another embodiment, the predictive technologies discussed above in connection with Sections I to VI may be extended and expanded to include complex structures, e.g., structures other than simple (flat) coupons. In particular, the predictive technologies in the present embodiment may utilize arbitrary time-serial loading conditions in the analysis of complex structures. For example, present embodiment provides a method and apparatus for the forewarning of imminent failure in a complex structure is disclosed. The method and apparatus include: sensing stress and strain displacement-related data for said structural element(s); analyzing the sensed stress and strain displacement-related data to extract one or more principle components; calculating the hysteresis strain energy (HSE) for each principle component; summing the hysteresis strain energy over all principle components; applying a zero-phase quadratic filter to the HSE data versus time to obtain HSE slope and HSE curvature; comparing HSE slope and HSE curvature to upper and lower control limits; and providing a forewarning of failure when one (or more) of the control limits is exceeded.

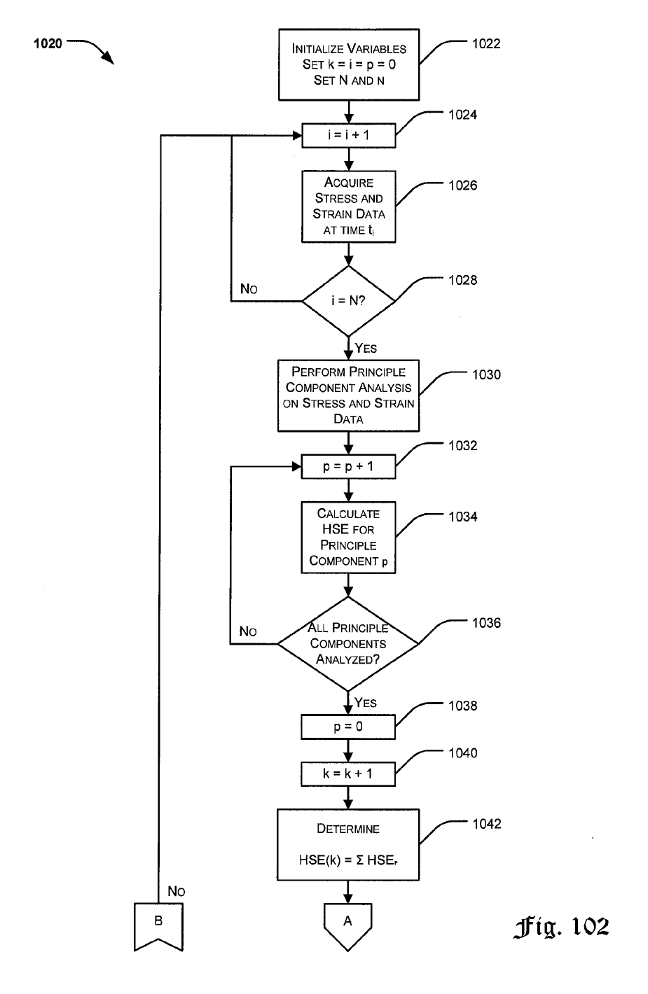

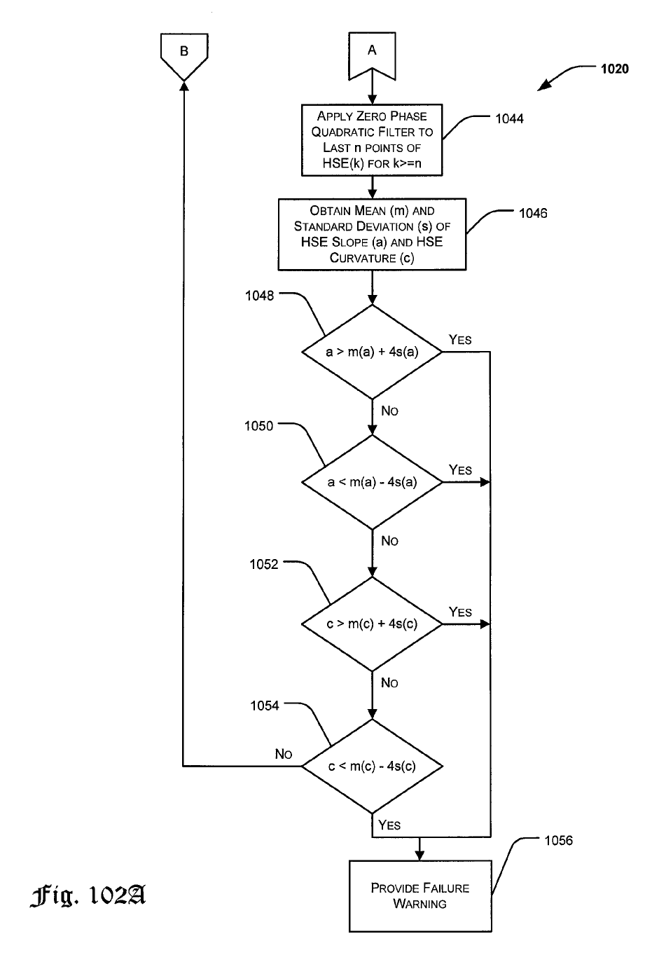

FIG. 102 is a flowchart 1020 detailing one embodiment or procedure for detecting the imminent structural failure of a complex structure. The embodiment detailed in FIG. 102 may be utilized to reduce the labor and material costs otherwise necessary to inspect a complex structure such as, for example, a bridge. The embodiment allows for automatic, continuous and near real-time failure prediction of a structure. The steps, procedures and/or algorithms disclosed and discussed herein may be implemented by, for example, a laptop or palmtop computer in communication with one or more sensors deployed on or embedded in the structure of interest. Alternatively, a chip-based processor could be embedded with the sensor.

At block 1022, the process begins with initialization of the system or process variables such as the counter variables k, i, p, N and n. The system or structure of interest may, in turn, be subjected to a known or arbitrary load P being dynamically applied. For example, if the structure of interest is a bridge, then the load P may be supplied by vehicular or foot traffic crossing or otherwise interacting with the bridge.

At block 1024, the counter variable i is incremented by one (1) and updated or stored to a suitable memory location.

At block 1026, one or more stress and strain sensors carried and positioned around the structure of interest may record, as a function of time, the mechanical stress and the strain applied to the structure. This time-serial stress and strain data may be stored, for example, on a computer readable medium such as a database or in any other known or foreseeable manner. The time-serial strain data may be gathered and recorded simultaneously with the time-serial stress data. The time-serial stress data and the time-serial strain data may be recorded as individual waveforms. Moreover, the time-serial strain data and the time-serial stress data may be synchronized as it is stored on the computer readable medium. It will be understood that the order in which the time-serial stress and strain data has been discussed herein does not reflect a preference or suggested recording or gathering order as these data from these two measurements is intended to be gathered simultaneously.

At block 1028, the counter variable i is compared to the total count variable N. If the counter variable i does not equal the total count variable N, then the process returns to block 1024. If the counter variable i equals the total count variable N, then the process continues to block 1030.

At block 1030, the gathered and synchronized time-serial stress and strain data can be analyzed and decomposed via principle component analysis. Principal components analysis in this exemplary embodiment decomposes a signal into a sum of orthogonal components, using the eigenfunctions of the covariance matrix of the signal, or equivalently singular value decomposition of the data matrix. This approach is based on the Karhunen-Loève theorem.

At block 1032, the component counter variable p is incremented by one (1) and updated or stored to a suitable memory location. The component counter variable p represents each of the principle components being analyzed.

At block 1034, for the p-th principle component within a given load/unload cycle resulting from the known or arbitrary load P, the component HSE may be determined according to:

HSEₚ=∫σₚ*dεₚ. (Equation 15)

The component HSEₚ, is the integral of the component stress, σₚ, multiplied by the change in component strain, dεₚ, over a load-unload cycle.

At block 1036, the component counter variable p is compared to the total number of components being analyzed. If all of the principle components represented by the component counter variable p have not been analyzed, then the process returns to block 1032. If the component counter variable p equals the total number of principle components, then the process continues to block 1038.

At block 1038, the component counter variable p may be reset or initialized to equal zero (0).

At block 1040, the counter variable k may be incremented by one (1) and updated or stored to a suitable memory location.

At block 1042, the total or composite HSE(k), may be determined as the sum over p of the individual HSEₚ components according to:

$$H S E ( k ) = {\sum }_{p} H S {E}_{p} = {\sum }_{P} ( \int {σ}_{p} * d {ɛ}_{p} ) \qquad ( Equation 16 )$$

At block 1044, a zero-phase quadratic filter is applied to the last n points of the composite HSE(k) when counter variable k is greater than or equal to n (k≧n). This exemplary zero-phase quadratic filter may be applied in accord with the exemplary method described in connection with equations 5 and 6 to determine the HSE slope and curvature.

At block 1046, composite HSE(k) relating to multiple load and unload cycles is analyzed according to disclosure discussed above in Sections I to VI to determine the mean (m), standard deviation (s) of the HSE slope (a) and HSE curvature (c).

At blocks 1048 to 1054, the upper and lower control limits are evaluated as a function of the mean (m), standard deviation (s) slope and curvature (c) of the HSE slope (a) and HSE curvature (c) determined at block 1046. The upper and lower control limits are represented as:

a>m(a)+4s(a)

a<m(a)−4s(a)

c>m(c)+4s(c)

c<m(c)−4s(c) (Equations 17 to 20)

If none of the upper and/or lower control limits at blocks 1048 to 1054 are satisfied, the process returns to block 1024 and begins again. If, however, any of the upper and/or lower control limits are violated, the process continues to block 1056.

At block 1056, the calculated and analyzed information can be used to provide a forewarning of a failure within the structure being evaluated. Specifically, if at least one of the control limits is exceeded, then an indication of failure forewarning is provided.

It should be understood that various changes and modifications to the presently preferred embodiments described herein will be apparent to those skilled in the art. Such changes and modifications can be made without departing from the spirit and scope of the present disclosure and invention and without diminishing its intended advantages. It is therefore intended that such changes and modifications be covered by the appended claims.

What is claimed is:

1. A method for the nonlinear detection of imminent failure in a complex structural element, the method comprising:
sensing stress and strain displacement-related data for said structural element;
analyzing the sensed stress and strain displacement-related data as a function of one or more principle components;
generating a crack-growth rate function relating said data to each principle component over a load/unload cycle;
determining a total crack-growth rate function based on at least one crack-growth rate function;
deriving from said total crack-growth rate function at least one indicator function;
monitoring trends in said at least one indicator function; and
providing an indication when said monitoring detects an end-stage trend in said at least one indicator function.

2. The method of claim 1, wherein generating the crack-growth rate function includes generating a crack-growth rate function relating said data to each principle component over a plurality of load/unload cycles.

3. The method according to claim 1, wherein said at least one indicator function is a function selected from the group consisting of: slope, curvature, and both slope and curvature of the hysteresis strain energy that is obtained from the sum of hysteresis strain energies over each principle component from the previous step.

4. The method according to claim 1, wherein said monitoring comprises deriving from said indicator function at least one limit function and comparing said indicator function to said limit function to determine when said indicator function and said limit function converge.

5. An apparatus for the nonlinear detection of imminent failure in a complex structural element, the apparatus comprising:
at least one sensor for sensing stress and strain displacement-related data for said structural element;
a processor in communication with said at least one sensor, the processor configured to:
analyze the sensed stress and strain displacement-related data as a function of one or more principle components;
generate a crack-growth rate function relating said data to each principle component over a load/unload cycle;
determine a total crack-growth rate function based on at least one crack-growth rate function;
derive from said total crack-growth rate function at least one indicator function;
monitor trends in said at least one indicator function; and
provide an indication when said monitoring detects an end-stage trend in said at least one indicator function.

6. The apparatus of claim 5, wherein the processor is further configured to generate a crack-growth rate function relating said data to each principle component over a plurality of load/unload cycles.

7. The apparatus of claim 5, wherein said at least one indicator function is a function selected from the group consisting of: HSE slope, HSE curvature, and both HSE slope and HSE curvature.

8. The apparatus of claim 5, wherein the processor if further configured to derive from said indicator function at least one limit function and compare said indicator function to said limit function to determine when said indicator function and said limit function converge.

9. A method for the nonlinear detection of imminent failure in a complex structural element, the method comprising:
analyzing stress and strain displacement-related data related to a complex structural element as a function of one or more principle components;
determining a total crack-growth rate function based on at least one of the analyzed principle components, wherein at least one indicator function is derived from the total crack-growth rate function;
monitoring at least one trend in the at least one indicator function; and
providing an indication when the monitoring detects an end-stage trend in the at least one indicator function.

10. The method of claim 9, wherein analyzing includes performing a principle component analysis one or more of the principle components of the complex structural element.

11. The method of claim 9 further comprising generating a crack-growth rate function relating said data to each principle component over a plurality of load/unload cycles.

12. The method according to claim 9, wherein said at least one indicator function is a function selected from the group consisting of: HSE slope, HSE curvature, and both HSE slope and curvature.

13. The method according to claim 12, wherein the slope and curvature of the hysteresis strain energy is obtained from the sum of hysteresis strain energies over each principle component from the previous step.

14. The method according to claim 9, wherein said monitoring comprises deriving from said indicator function at least one limit function and comparing said indicator function to said limit function to determine when said indicator function and said limit function converge.
